(19) United States
(12) Patent Application Publication
(10) Pub. No.: US 2009/0195561 A1
(43) Pub. Date: Aug. 6, 2009

(54) ELECTRO-OPTICAL DEVICE, DRIVING CIRCUIT AND DRIVING METHOD OF THE SAME, AND ELECTRONIC APPARATUS

(75) Inventors: Hidehito IISAKA, Shiojiri-shi (JP); Hiroyuki HOSAKA, Matsumoto-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/110,619

(22) Filed: Apr. 28, 2008

(30) Foreign Application Priority Data
May 18, 2007 (JP) 2007-132664

(51) Int. Cl. G09G 5/10

(52) U.S. Cl. 345/690

(57) ABSTRACT

A driving circuit of an electro-optical device includes a scanning line driving circuit and a data line driving circuit. When a writing scanning line is selected, the data line driving circuit supplies a data signal of an on or off voltage allocated to a sub-field corresponding to the selection in terms of a gray scale of the pixel corresponding to the selected one of the writing scanning lines and one of the data lines. Among the plurality of sub-fields, the length of a time period of the shortest sub-field is set shorter than the length of a time period required to select, by the scanning line driving circuit, the plurality of writing scanning lines.

### BACKGROUND

1. Technical Field

The present invention relates to a technology for making a display element perform gray scale in such a manner that one field is divided into a plurality of sub-fields and then an on or off voltage is applied to the display element in each of the sub-fields.

2. Related Art

When the gray scale is performed in an electro-optical device that uses display elements, such as liquid crystal elements, as pixels, the following technology has been proposed as a substitute for a voltage modulation method. That is, there has been proposed a technology for performing gray scale in such a manner that one field is divided into a plurality of sub-fields and then an on or off voltage is applied to the pixels (liquid crystal elements) in each sub-field to thereby change the percentage of time during which an on voltage (off voltage) is applied to the pixels in the one field, which is described in JP-A-2003-114661. Moreover, in the above technology, using the feature that the response speed of the liquid crystal elements is relatively slow, that is, specifically, using the feature that, even when an on voltage is applied to the liquid crystal elements in only one sub-field, the reflectance ratio (or transmittance ratio) of each liquid crystal element does not reach black color that corresponds to an on state (is not saturated), the reflectance ratio of each liquid crystal element is minutely controlled.

However, in the above technology, there has been a problem that it is difficult to obtain a desirable brightness when a gray scale that is one or a few levels darker than a gray scale corresponding to the highest brightness or, on the contrary to this, a gray scale that is one or a few levels brighter than a gray scale corresponding to the lowest brightness (gray scales near the upper or lower limit) needs to be displayed. Note that, when gray scales near the upper or lower limit are displayed, it is only necessary to set the length of a time period of each sub-field that constitutes one field short; however, there is a problem that, if the length of a time period of each sub-field is set excessively short, time required for scanning to apply an on or off voltage to each pixel cannot keep up with the length of the time period.

### SUMMARY

An advantage of some aspects of the invention is that it provides an electro-optical device that is capable of appropriately displaying gray scales, a driving circuit of the electro-optical device, a method of driving the electro-optical device, and an electronic apparatus.

An aspect of the invention provides a driving circuit of an electro-optical device. The electro-optical device includes a plurality of writing scanning lines, a plurality of data lines and a plurality of pixels arranged at positions corresponding to intersections of the writing scanning lines and the data lines. Each of the pixels, when a corresponding one of the writing scanning lines is selected, enters a state in accordance with a data signal supplied to the corresponding one of the data lines. The electro-optical device performs gray scale by applying at least one of an on voltage or an off voltage to each of the pixels for each of a plurality of sub-fields into which one field is divided. The driving circuit includes a scanning line driving circuit and a data line driving circuit. The scanning line driving circuit selects the plurality of writing scanning lines in a predetermined order. Among the sub-fields that constitute the one field, at least two sub-fields are set for the different lengths of time periods from each other. In each sub-field of the one field, whether to apply an on or off voltage is allocated to each of the pixels in advance in accordance with gray scales that are specified to the pixels. The data line driving circuit, when one of the writing scanning lines is selected, supplies a data signal of an on or off voltage allocated to a sub-field corresponding to the selection in terms of a gray scale of the pixel corresponding to the selected one of the writing scanning lines and one of the data lines. Among the plurality of sub-fields, the length of a time period of the shortest sub-field is set shorter than the length of a time period required to select, by the scanning line driving circuit, the plurality of writing scanning lines. According to the aspect of the invention, because, among a plurality of sub-fields that constitute one field, the length of a time period of a portion of sub-fields may be set short, it is possible to appropriately display gray scales, particularly, gray scales around the upper or lower limit.

In the aspect of the invention, the driving circuit may be configured so that the writing scanning lines are formed in a row direction and the data lines are formed in a column direction, wherein the scanning line driving circuit includes a shift register and logic circuits, wherein the shift register has stages that are provided in correspondence with the plurality of rows of writing scanning lines and sequentially transfers a pulse, which is supplied at a time interval in accordance with each of the sub-fields, over the stages in accordance with a clock signal, wherein the logic circuits each are provided for each of the plurality of rows of writing scanning lines, wherein each of the logic circuits logically operates a pulse that is overlappingly output from the stages of the shift register so as not to overlap one another among the plurality of rows and supplies the pulse to a corresponding one of the writing scanning lines as a scanning signal that indicates selection. According to the above configuration, it is so-called region scanning driving, so that it is easy to apply an on or off voltage to the pixels in the sub-field that is set short. Here, the number of pulses that are overlappingly output from the stages of the shift register may be “2”, wherein the logic circuit provided in each of the rows may output a logical multiplication signal of an enable signal and the shift register, and wherein different enable signals may be output between in the odd-numbered rows and in the even-numbered rows. Thus, it is possible to simplify the configuration of the scanning line driving circuit. In addition, the driving circuit may be configured so that the one field is divided into p (p is an integer that is equal to or more than two) groups and then each group is divided into two sub-fields, wherein the p groups are set to have the same length of a time period and the periods of the two sub-fields that constitute each group are respectively set short and long. Thus, a pulse may be supplied to the shift register in accordance with the short period or the long period.

In the aspect of the invention, the driving circuit may be configured so that an erasing scanning line is provided so as to be paired with each of the plurality of writing scanning lines, wherein each of the pixels, when a corresponding one of the erasing scanning lines is selected, is applied with an off voltage irrespective of the data signal, wherein the scanning line driving circuit selects one of the writing scanning lines in order to write an on or off voltage to each of the pixels in accordance with the sub-field of which the time period is the shortest and, when the time period of that sub-field has elapsed from the selection, selects the erasing scanning line that is paired with the one of the writing scanning lines. According to the above configuration, even when region scanning driving is not employed, it is easy to apply an on or off voltage to the pixels in the sub-field of which the period is set short.

In the aspect of the invention, the driving circuit may be configured so that each of the pixels includes a liquid crystal element, wherein, among the sub-fields, the length of a time period of the shortest sub-field is set shorter than saturation response time that takes until the reflectance ratio or transmittance ratio of the liquid crystal element is saturated when the on voltage is applied to the liquid crystal element. In this manner, in the aspect of the invention, the length of a time period of the shortest sub-field need not be dependent on selection of the scanning line or saturation response time of the liquid crystal element. In the aspect of the invention, the driving circuit may be configured so that, among displayable gray scales, in regard to a gray scale that is one level darker than the brightest gray scale, one of an on or off voltage is applied to each of the pixels in the sub-field that is set to the shortest length of a time period and the other one of an on or off voltage is applied to each of the pixels in another sub-field, and, among the displayable gray scales, in regard to a gray scale that is one level brighter than the darkest gray scale, the other one of an on or off voltage is applied to each of the pixels in the sub-field that is set to the shortest length of a time period and the one of an on or off voltage is applied to each of the pixels in the another sub-field. In addition, in the aspect of the invention, the driving circuit may be configured so that, in the sub-field, each of the pixels is applied with any one of the on voltage, the off voltage or an intermediate voltage that is set to a voltage between the on voltage and the off voltage. Thus, when an intermediate voltage state is further added in addition to an on voltage and an off voltage, it is possible to increase the number of addressable luminance levels that can be displayed without changing the array of sub-fields. Then, the plurality of intermediate voltages, equal to or more than two (somewhat bright, somewhat dark, or the like), may be employed. Note that the aspects of the invention are not limited to the driving circuit of the electro-optical device, but they may be applied to a method of driving the electro-optical device, the electro-optical device itself, and, moreover, an electronic apparatus that is provided with the electro-optical device.

### BRIEF DESCRIPTION OF THE DRAWINGS

The invention will be described with reference to the accompanying drawings, wherein like numbers reference like elements.

FIG. 1 is a view that shows the overall configuration of an electro-optical device according to a first embodiment of the invention.

FIG. 2 is a view that shows the configuration of pixels in the electro-optical device.

FIG. 3 is a view that shows the configuration of sub-fields used in the electro-optical device.

FIG. 4 is a view that shows patterns of gray scale performed by the electro-optical device.

FIG. 5 is a view that shows the gray-scale characteristics performed by the electro-optical device.

FIG. 6 is a view that shows the on-off conversion of each sub-field in the electro-optical device.

FIG. 7 is a view that shows the configuration of a scanning line driving circuit in the electro-optical device.

FIG. 8 is a timing chart that shows the operation of the scanning line driving circuit.

FIG. 9 is a view that shows scanning signals generated by the scanning line driving circuit.

FIG. 10 is a view that shows an example of writing in each sub-field in the electro-optical device.

FIG. 11A to FIG. 11C are views that show the progress of writing in each sub-field in the electro-optical device.

FIG. 12 is a view that shows the progress of writing of a first application example according to the first embodiment.

FIG. 13 is a view that shows the example of writing of a second application example according to the first embodiment.

FIG. 14 is a view that shows another configuration of sub-fields used in the electro-optical device.

FIG. 15 is a view that shows the configuration of sub-fields used in an electro-optical device according to a second embodiment.

FIG. 16 is a view that shows the configuration of pixels of the electro-optical device.

FIG. 17 is a view that shows the configuration of a scanning line driving circuit in the electro-optical device.

FIG. 18 is a timing chart that shows the operation of the scanning line driving circuit.

FIG. 19 is a timing chart that shows the operation of the scanning line driving circuit.

FIG. 20 is a view that shows the progress of writing in each sub-field used in the electro-optical device.

FIG. 21 is a view that shows the configuration of a projector that uses the electro-optical device according to the embodiments.

FIG. 22 is a view that shows patterns of gray scale performed by an electro-optical device according to a comparative embodiment.

FIG. 23 is a view that shows the gray-scale characteristics performed by the electro-optical device according to the comparative embodiment.

FIG. 24 is a view that shows the progress of writing in the electro-optical device according to the comparative embodiment.

### DESCRIPTION OF EXEMPLARY EMBODIMENTS

Embodiments of the invention will now be described with reference to the accompanying drawings.

### First Embodiment

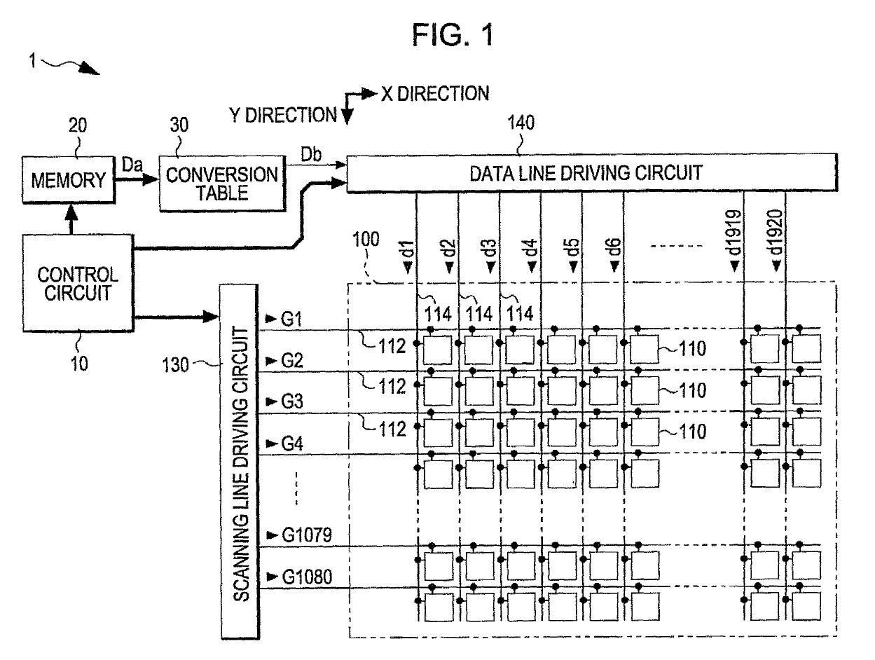

First, a first embodiment of the invention will be described. FIG. 1 is a block diagram that shows the overall configuration of an electro-optical device 1 according to the first embodiment. As shown in the drawing, the electro-optical device 1 roughly includes a control circuit 10, a memory 20, a conversion table 30, a display circuit 100, a scanning line driving circuit 130 and a data line driving circuit 140. The control circuit 10 controls portions of the electro-optical device 1, as will be described later. The display circuit 100 includes pixels that are arranged in a matrix. Specifically, the display circuit 100 includes 1080 scanning lines (writing scanning lines) 112 that extend in a horizontal X direction in the drawing and 1920 data lines 114 that are electrically insulated from the scanning lines 112 and that extend in a vertical Y direction in the drawing. Then, the pixels 110 are provided at portions corresponding to intersections of the scanning lines 112 and the data lines 114. Thus, in the present embodiment, the pixels 110 are arranged in a matrix of 1080 rows by 1920 columns; however, the aspects of the invention are not intended to be limited to this arrangement.

The memory 20 includes storage areas that correspond to the pixels arranged in 1080 rows by 1920 columns. Each of the storage areas stores the display data Da of a corresponding one of the pixels 110. Each piece of the display data Da specifies the brightness (gray-scale level) of the pixel 110 and, in the present embodiment, specifies the brightness in 16 levels in steps of one level from “0” to “15”. Here, the gray-scale level “0” specifies black color, which is the lowest gray scale. As the gray-scale level increases, the brightness gradually increases. The gray-scale level “15” specifies white color, which is the highest gray scale. Note that the display data Da are supplied from an upper level device (not show) and are stored in the storage area corresponding to the pixel by the control circuit 10, while, on the other hand, the data corresponding to the pixel that is scanned by the display circuit 100 are read out from the memory 20. The conversion table 30 converts the display data Da, which have been read out from the memory 20, to data Db that indicate which one of an on voltage or an off voltage should be applied to the pixel 110 (liquid crystal element) in accordance with the gray-scale level specified by the display data Da and the sub-field. Note that the above conversion will be described later.

### Configuration of Pixels

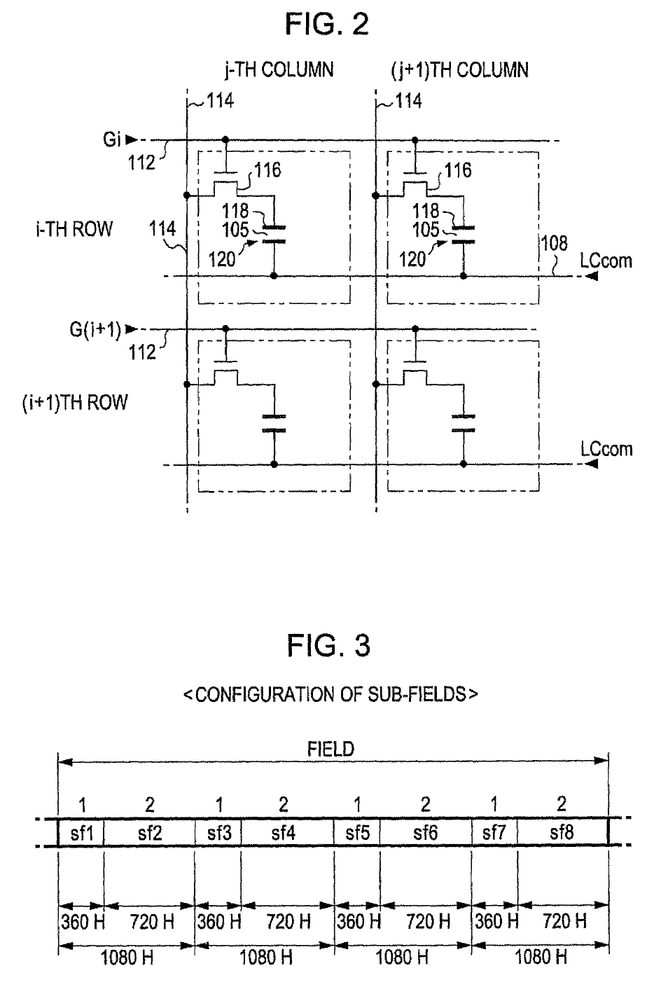

For easier description, the configuration of the pixels 110 will be described with reference to FIG. 2. FIG. 2 is a view that shows the detailed configuration of the pixels 110, showing the configuration of two by two, that is, four pixels in total, arranged at portions corresponding to intersections of the i-th row or the adjacent (i+1)th row and the j-th column or the adjacent (j+1)th column. Here, and (i+1) are symbols that generally indicate a row in which the pixels 110 are arranged and, in the present embodiment, are integers, each of which ranges from 1 to 1080. In addition, j and (j+1) are symbols that generally indicate a column in which the pixels 110 are arranged and are integers, each of which ranges from 1 to 1920.

As shown in FIG. 2, each of the pixels 110 includes an n-channel transistor (MOSFET) 116 and a liquid crystal element 120. Here, because each of the pixels 110 has the same configuration, the description will be made representatively using the pixel 110 located at the i-th row and j-th column. In the i-th row and j-th column pixel 110, the gate electrode of the transistor 116 is connected to the i-th scanning line 112, while the source electrode thereof is connected to the j-th column data line 114 and the drain electrode thereof is connected to a pixel electrode 118, which is one end of the liquid crystal element 120. In addition, the other end of the liquid crystal element 120 is an opposite electrode 108. The opposite electrode 108 is common to all the pixels 110 and, in the present embodiment, is maintained at a voltage LCcom.

The display circuit 100 includes an element substrate, an opposite substrate and a liquid crystal 105. The scanning lines 112, the data lines 114, the transistors 116, the pixel electrodes 118, and the like, are formed on the element substrate. The opposite electrode 108 is formed on the opposite substrate. The element substrate and the opposite substrate are spaced at a certain gap in between, and are adhered so that electrode forming faces of both substrates are opposite each other. The liquid crystal 105 is sealed in the gap. The above configuration is not shown in the drawing. Therefore, in the present embodiment, the liquid crystal element 120 is configured so that the pixel electrodes 118 and the opposite electrode 108 hold the liquid crystal 105. Note that, in the present embodiment, the liquid crystal element 120 is of a reflective LCOS (Liquid Crystal on Silicon) type in which the element substrate uses a semiconductor substrate and the opposite substrate uses a transparent substrate, such as glass. Therefore, on the element substrate, in addition to the scanning line driving circuit 130 and the data line driving circuit 140, the control circuit 10, the memory 20 and the conversion table 30 all may be formed.

In the above configuration, when the transistor 116 is made into an on state (conductive state) by applying a selection voltage to the scanning line 112 and a data signal is supplied to the pixel electrode 118 through the data line 114 and the transistor 116, which is in an on state, a voltage difference between the voltage of the data signal and the voltage LCcom applied to the opposite electrode 108 is written to the liquid crystal element 120 that is located at a position corresponding to the intersection of the scanning line 112, to which the selection voltage is applied, and the data line 114, to which the data signal is supplied. Note that, as the scanning line 112 attains a non-selection voltage, the transistor 116 enters an off (non-conductive) state; however, in the liquid crystal element 120, the voltage that has been written at the time when the transistor 116 enters a conductive state is held by its capacitive property.

In the present embodiment, the liquid crystal element 120 is set to a normally black mode. Therefore, the reflectance ratio (transmittance ratio in the case of transmissive type) of the liquid crystal element 120 becomes smaller as the effective value of a voltage difference between the pixel electrode 118 and the opposite electrode 108 decreases. In a state where no voltage is applied, the liquid crystal element 120 substantially appears black color. However, in the present embodiment, only any one of an on voltage that sets the above voltage difference equal to or higher than a saturation voltage and an off voltage that is equal to or lower than a threshold value is applied to the pixel electrode 118.

In the normally black mode, when the reflectance ratio in the darkest state is defined as a relative reflectance ratio 0% and the reflectance ratio in the brightest state is defined as a relative reflectance ratio 100%, within the voltage applied to the liquid crystal element 120, a voltage of which the relative reflectance ratio is 10% is an optical threshold voltage and a voltage of which the relative reflectance ratio is 90% is an optical saturation voltage. In the voltage modulation method (analog driving), it is designed so that, when the liquid crystal element 120 is made to a halftone (gray color), a voltage that is equal to or lower than the optical saturation voltage is applied to the liquid crystal 105. For this reason, the reflectance ratio of the liquid crystal 105 is a value that is substantially proportional to a voltage applied to the liquid crystal 105. In contrast, in the present embodiment, gray scale is performed using only two voltages, that is, an on voltage and an off voltage, as a voltage applied to the liquid crystal element 120. Specifically, in the present embodiment, the gray scale is executed in such a manner that one field is divided into a plurality of sub-fields and then a time period during which an on or off voltage is applied to the liquid crystal element 120 is distributed in units of sub-field.

In the present embodiment, the voltage used as an on voltage employs a voltage that is about 1 to 1.5 times as high as the saturation voltage. This is because the rising of the response characteristics of the liquid crystal is substantially proportional to a voltage level applied to the liquid crystal element and, therefore, it is desirable to improve the response characteristics of the liquid crystal. In addition, the voltage used as an off voltage employs a voltage that is equal to or lower than the optical threshold voltage of the liquid crystal element 120. Note that the actual reflectance ratio of the liquid crystal element is approximately proportional to an integration value in a time period during which an on voltage is applied because of the response of the liquid crystal; however, for the sake of simple description, it may be described so that the actual reflectance ratio is proportional to a time period during which an on voltage is applied.

### Configuration of Sub-Fields

Then, first, the configuration of sub-fields in the present embodiment will be described with reference to FIG. 3. In the drawing, one field means a time period that is necessary to form one image and means the same as a frame in an non-interlaced method. One field is fixed and has a constant period of 16.7 milliseconds (which corresponds to one frequency of 60 Hz). As shown in the drawing, in the present embodiment, a time period of one field is equally divided into four groups and, furthermore, each group is divided into two sub-fields. Therefore, one field is divided into eight sub-fields in total; however, for the sake of convenience, the sub-fields are termed as sf1, sf2, sf3, . . . , sf8 in the order from the first sub-field in the one field.

Here, where one cycle of a clock signal Cly, which will be described later, is denoted as 1H, the length of a time period of each group is 1080H and, therefore, the length of a time period of one field is 4320(=1080×4)H In addition, the length of a time period of each of the odd-numbered sub-fields sf1, sf3, sf5 and sf7 is set to 360H, and the length of a time period of each of the even-numbered sub-fields sf2, sf4, sf6 and sf8 is set to 720H. Thus, when the ratio of the length of a time period of each of the odd-numbered sub-fields sf1, sf3, sf5 and sf7 is defined as “1”, the ratio of the length of a time period of each of the even-numbered sub-fields sf2, sf4, sf6 and sf8 is “2”, so that the ratio of the length of a time period of one field is “12”. Note that the fields are continuous in terms of time and, therefore, the sub-field sf8 of a field adjoins the sub-field sf1 of the next field.

### Gray Scale

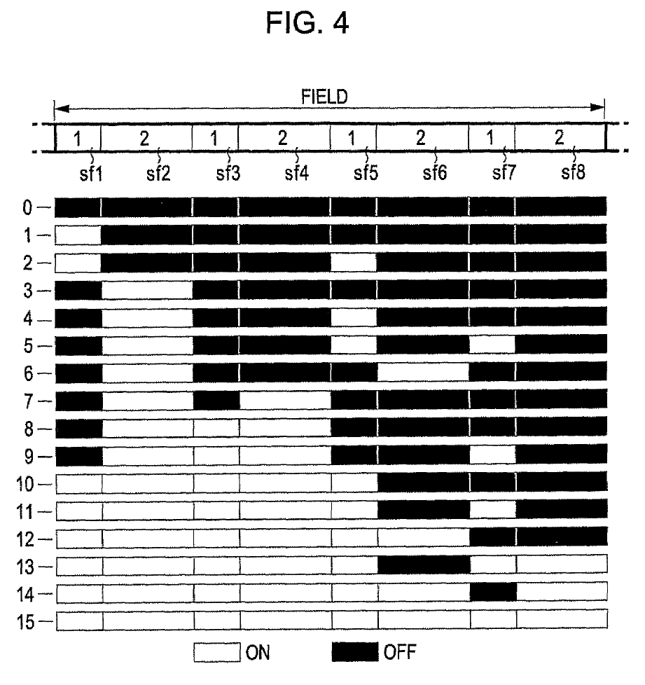

Next, performing the gray scale in what manner to apply an on or off voltage in the above sub-fields sf1 to sf8 will be described. FIG. 4 is a view that shows the allocation of on or off to the sub-fields sf1 to sf8 for each of the gray-scale levels “0” to “15”. In the drawing, outline rectangular symbol or solid rectangular symbol corresponding to each sub-field each has a length of a time period of a corresponding one of the sub-fields. The outline rectangular symbol indicates that an on voltage (white color) is applied to the liquid crystal element 120, and the solid rectangular symbol indicates that an off voltage (black color) is applied to the liquid crystal element 120.

In the present embodiment, as described above, because the liquid crystal element 120 is set to a normally black mode, for the liquid crystal element 120 of each pixel that is specified to “0” of which the gray-scale level is the lowest, an off voltage is applied over all the sub-fields sf1 to sf8. Thus, when one field is regarded as unit time, it appears black color display, which is the lowest gray scale. Next, for the liquid crystal element 120 of each pixel of which the gray-scale level is specified to “1”, among the sub-fields that constitute one field, only the sub-field sf1, which has the shortest time period and which is located on the most preceding side in terms of time, is applied with an on voltage. Thus, it is possible to perform display that is closest to black color of the pixel, to which the gray-scale level “0” is specified, and that is brighter than the black color. Note that the reason why, when the gray-scale level is “1”, the sub-field, to which an on voltage is applied, is set for sf1 that is located on the most preceding side in terms of time in one field is to make the liquid crystal quickly respond to switching of fields.

Subsequently, the case in which the gray-scale level is “3” will be described in advance of the case in which the gray-scale level is “2”. For the liquid crystal element 120 of each pixel to which the gray-scale level “3” is specified, only the sub-field sf2 that is longer than the sub-field sf1 to which an on voltage is applied when the gray-scale level is “1”, and that is located on the most preceding side in terms of time is applied with an on voltage. In this manner, the actual reflectance ratio in the liquid crystal element 120 of the pixel to which the gray-scale level “3” is specified is brighter than the actual reflectance ratio in the liquid crystal element of the pixel to which the gray-scale level “1” is specified.

Here, For the liquid crystal element 120 of each pixel to which the gray-scale level “2” is specified, it is only necessary that the actual reflectance ratio falls between the gray-scale level “1” and the gray-scale level “3” (desirably, set designed value). Therefore, for the liquid crystal element 120 of each pixel to which the gray-scale level “2” is specified, an on voltage is applied not only in the sub-field sf1 to which an on voltage is applied when the gray-scale level is “1” but also in the sub-field sf5 of which the sum with the ratio of the sub-field sf1 is equal to or lower than the ratio “2” of the sub-field sf2 to which an on voltage is applied when the gray-scale level is “3”. In this manner, the actual reflectance ratio in the liquid crystal element 120 of the pixel to which the gray-scale level “2” is specified is brighter than the actual reflectance ratio in the liquid crystal element of the pixel to which the gray-scale level “1” is specified.

As an on voltage is applied in the sub-fields sf1 and sf5, the sum of the ratios of the lengths of time periods of the sub-fields to which an on voltage is applied in one field is “2”. This is the same as in the case in which the gray-scale level is “3”. However, as described above, the actual reflectance ratio of the liquid crystal element is proportional to an integration value of a time period during which an on voltage is applied. For this reason, the gray-scale level “2” in which an on voltage is applied in the sub-fields sf1 and sf5, each of which has a ratio “1”, with a time interval in between is darker in the actual reflectance ratio of the liquid crystal element than the gray-scale level “3” in which an on voltage is applied over the sub-field sf2, which has a ratio “2”. Thus, the actual reflectance ratio in the liquid crystal element 120 to which the gray-scale level “2” is specified falls between the gray-scale level “1” and the gray-scale level “3”.

In the present embodiment, with respect to the sub-field sf1, the sub-fields sf3, sf5 and sf7 each are set to the ratio “1” of the same length of a time period, and the sub-fields sf2, sf4, sf6 and sf8 each are set to the ratio “2” of the length of a time period. Thus, the sub-field of which the sum of the ratios, with the sub-field sf1, is equal to or smaller than “2” is sf3, sf5 or sf7. Among them, in the present embodiment, an on voltage is applied in the sub-field sf5. This is because sf5 is desirable in order to obtain the required reflectance ratio in terms of design. If, in the gray-scale level “2”, brighter reflectance ratio is required in terms of design, it is only necessary to apply an on voltage in the sub-field sf3 or sf7. This is because, as on voltage is applied in the sub-fields sf1 and sf3 (sf1 and sf7), in comparison with the case in which an on voltage is applied to the sub-fields sf1 and sf5, a time interval between the sub-fields in which an on voltage is applied decreases and, therefore, even when the sum of the ratios of the lengths of time periods is the same, the actual reflectance ratio becomes brighter. Note that it seems that the sub-field sf3 is closer in terms of time to the sub-field sf1 than the sub-field sf7; however, the time interval between sf1 and sf3 is the same as the time interval between sf1 and sf7. This is because, as described above, fields are repeated and continuous and the sub-field sf7 in a field is approximate in terms of time to the sub-field sf1 in the next field.

Next, for the liquid crystal element 120 of each pixel to which the gray-scale level 1141, is specified, an on voltage is applied not only in the sub-field sf2 in which an on voltage is applied when the gray-scale level is “3” but also in the sub-field sf5 that is located at a time interval from the sub-field sf2. In this manner, the actual reflectance ratio in the liquid crystal element 120 of the pixel to which the gray-scale level “14” is specified is brighter than the actual reflectance ratio in the liquid crystal element of the pixel to which the gray-scale level “3” is specified.

Subsequently, for the gray-scale level “161”, it is only necessary to set the sum of the lengths of time periods of the sub-fields, in which an on voltage is applied, to, for example, “4”, which is larger than the ratio 11311 when the gray-scale level is “4”. Therefore, for the liquid crystal element 120 of each pixel of which the gray-scale level “6” is specified, an on voltage is applied in the sub-field sf2 and in the sub-field sf6 that is located at a time interval from the sf2. In this manner, the actual reflectance ratio in the liquid crystal element 120 of the pixel to which the gray-scale level “6” is specified is brighter than the actual reflectance ratio in the liquid crystal element of the pixel to which the gray-scale level “4” is specified. Here, for the liquid crystal element 120 of each pixel to which the gray-scale level “5” is specified, it is only necessary that the actual reflectance ratio falls between the gray-scale level “4” and the gray-scale level “6” (desirably, set designed value). Therefore, for the liquid crystal element 120 of each pixel to which the gray-scale level “5” is specified, an on voltage is applied not only in the sub-fields sf2 and sf5 in which an on voltage is applied when the gray-scale level is “4” but also in the sub-field sf7 of which the sum with the ratios of the sub-fields sf2 and sf5 is equal to or smaller than the sum “4” of the rations of the sub-fields sf2 and sf6 in which an on voltage is applied when the gray-scale level is “6”. In this manner, the actual reflectance ratio in the liquid crystal element 120 of the pixel to which the gray-scale level “5”, is specified is brighter than the actual reflectance ratio in the liquid crystal element of the pixel to which the gray-scale level “4” is specified. As an on voltage is applied in the sub-field sf7, in addition to the sub-fields sf2 and sf5, for the gray-scale level “5”, the sum of the ratios of the lengths of time periods of the sub-fields in which an on voltage is applied within one field is “4”. This is the same as in the case of the gray-scale level “6”. However, in the gray-scale level “5”, within the ratio “4”, in which an on voltage is applied, the ratio “2” in each of the sub-fields sf5 and sf7 is located at a time interval therebetween. Thus, in comparison with the gray-scale level “6” of which the ratio “2” is part of the sub-field sf6 and not separated, the actual reflectance ratio of the liquid crystal element is darker. Thus, the actual reflectance ratio in the liquid crystal element 120 to which the gray-scale level “5” is specified falls between the gray-scale level “4” and the gray-scale level “6”.

Next, for the gray-scale level “7”, by applying an on voltage in the sub-fields sf2 and sf4, the time interval between the sub-fields in which an on voltage is applied is smaller than the case in which the gray-scale level is “6”. Therefore, even when the ratio by which an on voltage is applied is “4”, the actual reflectance ratio in the liquid crystal element 120 of the pixel to which the gray-scale level “7”, is specified is brighter than the actual reflectance ratio in the liquid crystal element of the pixel to which the gray-scale level “6” is specified. Note that, in FIG. 4, because the ratio by which an on voltage is applied is increased from “5” to “12” in a stepwise manner from the gray-scale level “8” to the gray-scale level “15”, the actual reflectance ratio of the liquid crystal element 120 also becomes brighter in a stepwise manner.

Here, for the liquid crystal element 120 of each pixel of which the highest gray-scale level “15” is specified, because an on voltage is applied over all the sub-fields sf1 to sf8, it appears white color display, which is the highest gray scale, when one field is regarded as unit time. For the gray-scale level “14” in which a gray scale that is one level darker than the gray-scale level “15” is specified, among the sub-fields that constitute one field, only the sub-field sf7 that is the longest in a time period and that is located on the most following side in terms of time is applied with an off voltage.

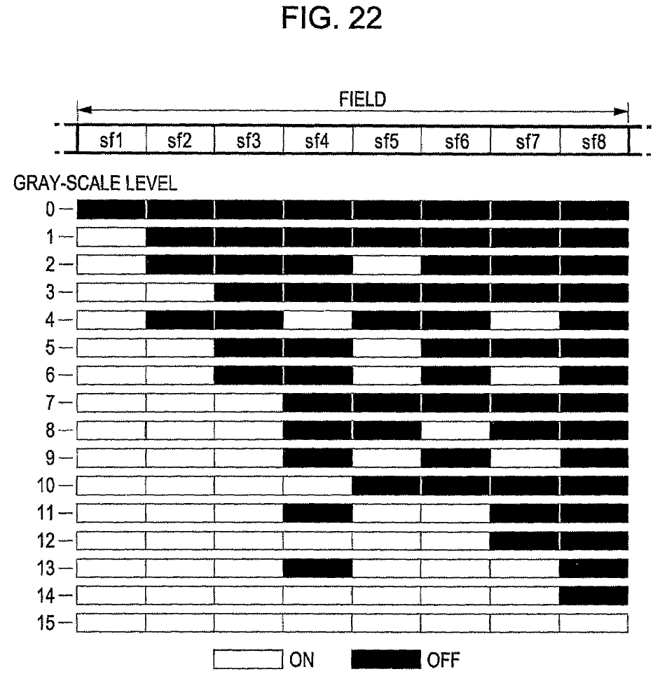

In order to describe the gray scale characteristics of the present embodiment, first, the problems in the comparative embodiment described in the background art will be described. FIG. 22 is a view that shows the allocation of an on voltage or an off voltage to the sub-fields sf1 to sf8 when the gray scale is performed in the gray-scale levels “0” to “15” using the technology described in the above background art. In FIG. 22, the number of sub-fields that constitute one field is “8” as well as the present embodiment; however, the time period of each sub-field is set equal to one another. In this technology as well, when the gray-scale level is “0”, an off voltage is applied over all the sub-fields, and, when the gray-scale level adjacent to the above level is “1”, an on voltage is applied only in one of the sub-fields, that is, the sub-field sf1 that is located on the preceding side in one field.

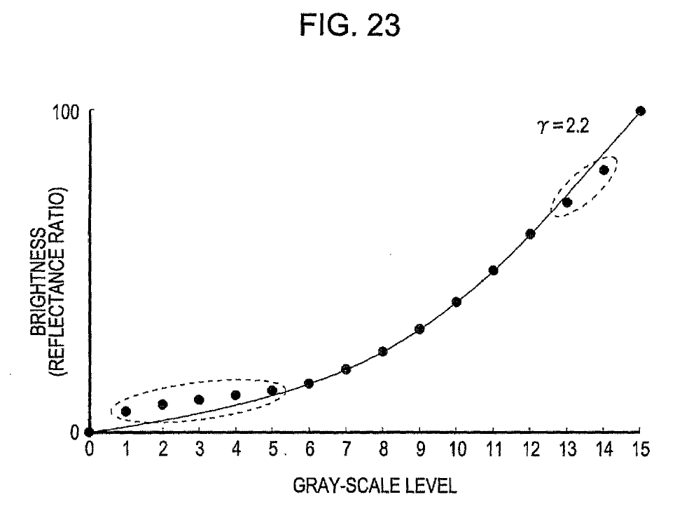

However, in the above technology, because the time period of each of the eight sub-fields is equal to one another, when the ratio of the length of a time period of one sub-field is defined as “1”, one sub-field occupies one eighth of one field. Thus, in the above technology, when the gray-scale level changes from “0” to “1”, a time period during which an on voltage is applied to the liquid crystal element in one field increases by one eighth with respect to a difference between the adjacent gray-scale levels. Thus, the actual brightness (reflectance ratio) when the gray-scale level “1” is specified in the liquid crystal element, as shown in FIG. 23, tends to be brighter than the required visual characteristics. Here, the gray-scale level “1”, which is one level brighter than the lowest gray-scale level “0”, is described; however, the similar tendency appears around the gray-scale level “1”, that is, the dark gray-scale levels other than the gray-scale level “0”. In addition, when the gray-scale level changes from “15” to “14”, a time period during which an on voltage is applied to the liquid crystal element in one field decreases by one eighth with respect to a difference in the adjacent gray-scale levels. Thus, the actual brightness, when the gray-scale level “14” is specified in the liquid crystal element, tends to be darker than the required visual characteristics, as shown in the drawing.

Note that it has been generally known that the visual characteristics of human beings have logarithmic or exponential property. Therefore, even when the gray-scale level linearly changes, the eyes of human beings do not recognize that it is linearly changing. In addition, in a display element, such as a liquid crystal element or an organic EL element (Electronic Luminescence), even when a voltage, or the like, linearly changes, the actual brightness of the display element exhibits a curved line. Owing to the above situation, in a display device, it has been generally performed that the brightness of the display element is converted into curved characteristics (γ characteristics) with respect to the gray-scale level that specifies the gray scale of a pixel in consideration of the visual characteristics of human beings. When the gray scale is expressed in accordance with such γ characteristics, a change in gray scale appears linearly when viewed by the eyes of human beings. Here, γ coefficient in the γ characteristics is ideally set to “2.2” when the liquid crystal element is used as a display element.

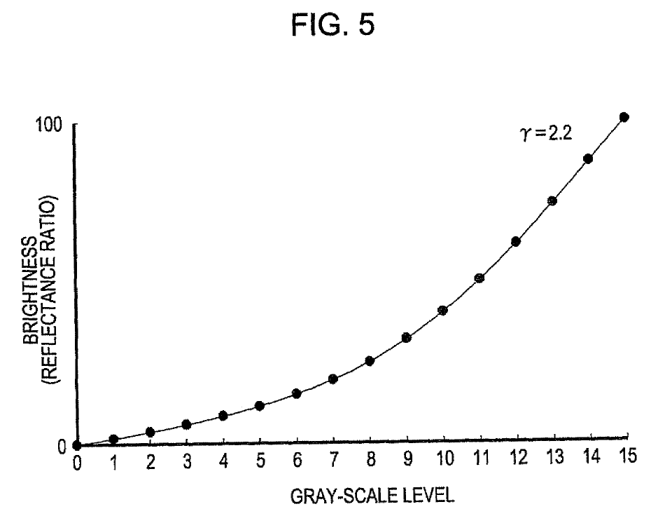

In the present embodiment, one field is divided into eight sub-fields; however, the length of a time period of each sub-field is set in such a manner that the ratios of the lengths time periods in one group are different from each other, like a short ratio “1” and a long ratio “2”. Thus, in the present embodiment, the shortest sub-field sf1 (sf3, sf5, sf7) occupies one twelfth of one field, which is shorter than one eighth thereof. Thus, according to the present embodiment, when the gray-scale level changes from “0” to “1”, a time period during which an on voltage is applied to the liquid crystal element in one field increases only by one twelfth of the one field with respect to a difference in the adjacent gray-scale levels. As a result, it is possible for the actual brightness (reflectance ratio), when the gray-scale level “1” is specified in the liquid crystal element, to substantially coincide with the required visual characteristics, as shown in FIG. 5. Note that, similarly, it is also possible for the gray-scale levels around the gray-scale level “1”, that is, the dark gray-scale levels other than the gray-scale level “0”, to substantially coincide with the required visual characteristics. In addition, when the gray-scale level changes from “15” to “14”, a time period during which an on voltage is applied to the liquid crystal element in one field decreases only by one twelfth with respect to a difference in the adjacent gray-scale levels. It is also possible for the actual brightness, when the gray-scale level “14” (and gray-scale levels therearound) is specified in the liquid crystal element, to substantially coincide with the required visual characteristics, as shown in the drawing.

### Conversion Using Conversion Table

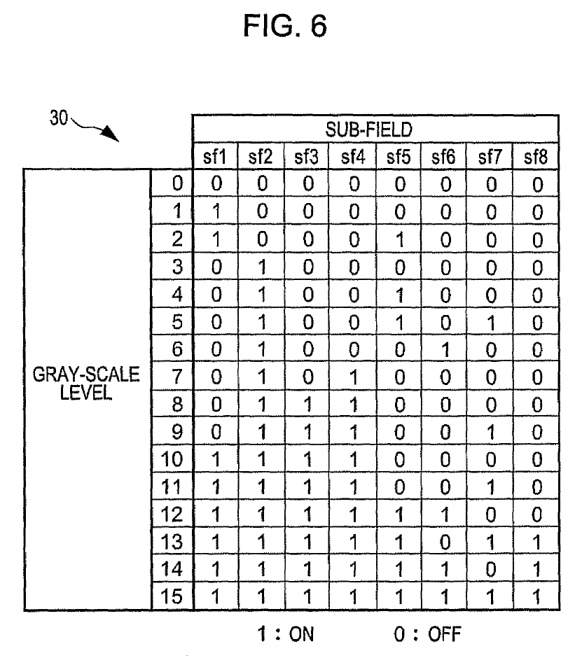

Next, the conversion using the conversion table 30 for actually performing the above described gray scale will be described with reference to FIG. 6. As shown in the drawing, in the conversion table 30, a gray-scale level that is specified by the display data Da read out from the memory 20 is converted into data Db that specify any one of an on voltage or an off voltage to the liquid crystal element 120 for each of the sub-fields sf1 to sf8. Note that, in the drawing, “1” means to specify applying an on voltage to the liquid crystal element 120 and “0” means to specify applying an off voltage to the liquid crystal element 120. For example, when the gray-scale level is “5”, it is specified to apply an on voltage to the liquid crystal element 120 in the sub-fields sf2, sf5 and sf7 and to apply an off voltage to the liquid crystal element 120 in the other sub-fields. By applying in each of the sub-fields an on voltage or an off voltage to the liquid crystal element in accordance with the data Db that are converted using the conversion table, it is possible to achieve the gray scale as shown in FIG. 4.

### Scanning Line Driving Circuit

In the case in which an on voltage or an off voltage is applied to the liquid crystal element 120 in each of the sub-fields sf1 to sf8 as in the case of the present embodiment, when the scanning lines are simply selected in the order of first, second, third, fourth, . . . , 1079th and 1080th lines, it is necessary to complete selection of all the scanning lines within the time period of the shortest sub-field sf1. In other words, when the scanning lines are selected in the order of first, second, third, fourth, 1079th and 1080th lines, it is necessary to set the length of the time period of the shortest sub-field sf1 equal to or longer than time required to select all the scanning lines. Thus, it is difficult to appropriately display gray-scales around the upper or lower limit. Then, in the present embodiment, using a technology described in JP-A-2004-177930, the scanning lines are selected not in the order of first, second, third, fourth, . . . , but in the order of skipping n lines, such as in the order of first, (n+1)th, second, (n+2)th, third, (n+3)th, fourth, (n+4)th, . . . (region scanning driving). However, in the present embodiment, it is necessary to consider the difference in the length of a time period between the even-numbered sub-field and the odd-numbered sub-field.

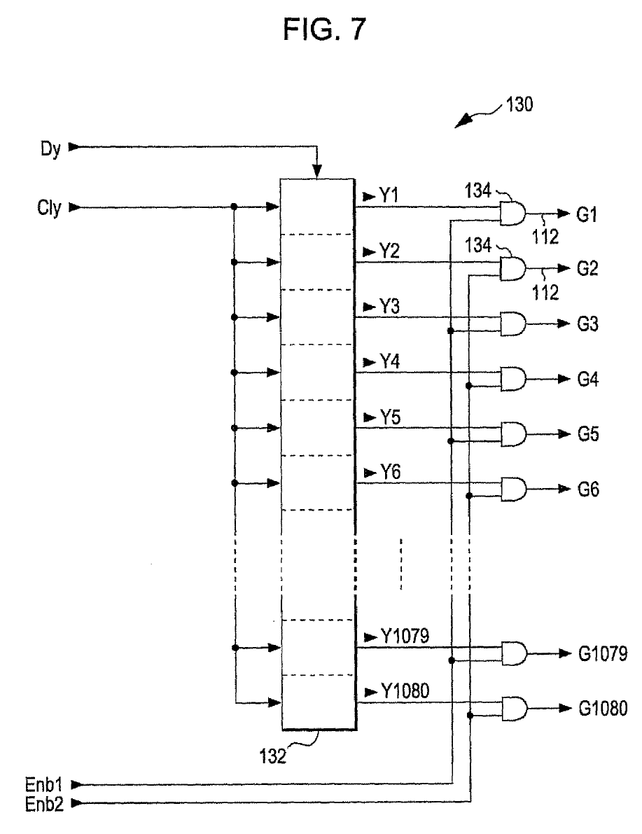

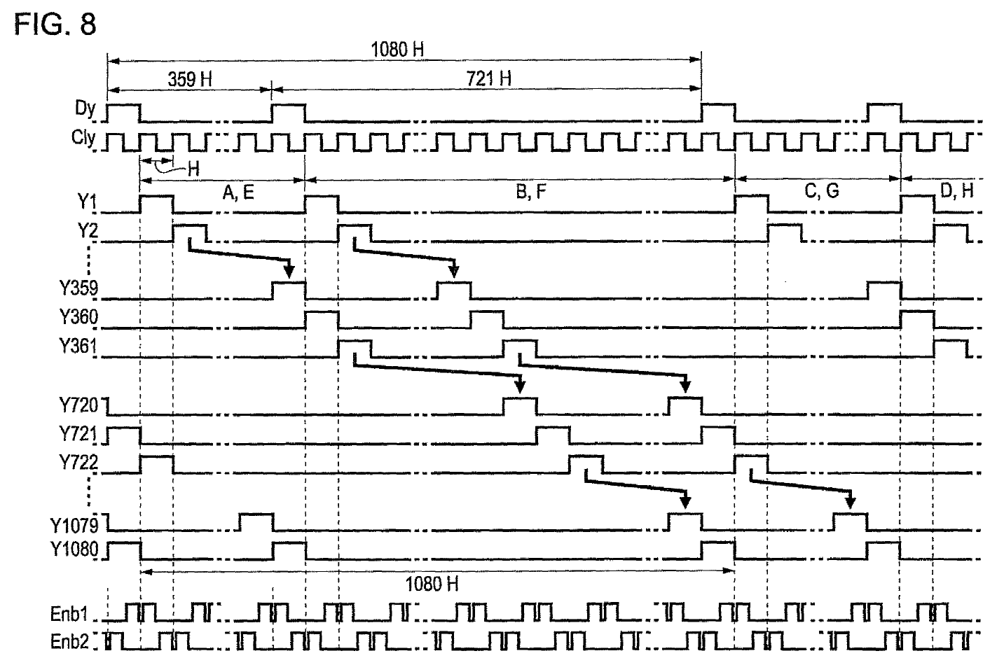

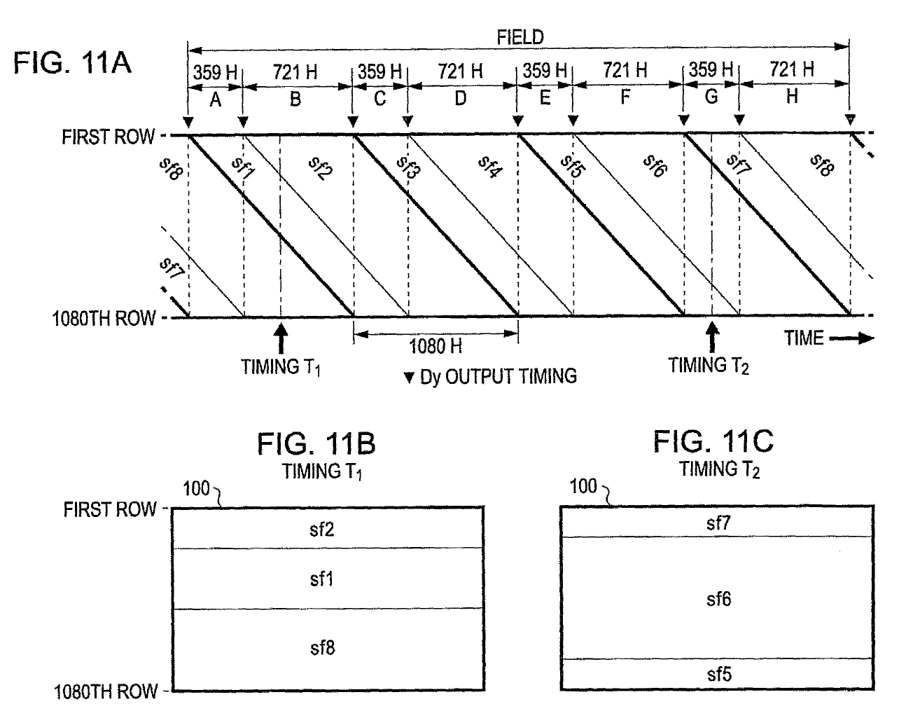

FIG. 7 is a block diagram that shows the configuration of the scanning line driving circuit 130 in the present embodiment. In the drawing, a clock signal Cly, a start pulse Dy, and enable signals Enb1 and Enb2 each are supplied from the control circuit 10. The clock signal Cly has a duty ratio of 50%. The start pulse Dy has a pulse width (H level) of one cycle of the clock signal Cly, as shown in FIG. 8 and is supplied so as to attain an H level in synchronization with the rising timing of the clock signal Cly. In the period of one field, the start pulse Dy is output as shown in FIG. 11A. Specifically, as shown in the drawing, in order to scan the scanning lines in the sub-field sf1 of a field, as the first start pulse Dy is output, the second start pulse Dy is output after 359 cycles of the clock signal Cly have elapsed. After that, the third start pulse Dy is output after 721 cycles of the clock signal Cly have elapsed. Thereafter, in accordance with the pattern of repeating 359 cycles and 721 cycles, the start pulse Dy is output from the fourth to the eighth.

As described above, in the present embodiment, because the scanning line driving circuit 130 performs interlaced scanning, when it is observed from the start of one field, there is a possibility that it is difficult to intuitively understand scanning (selection) of scanning lines by the scanning line driving circuit 130 and voltage writing in each sub-field. Then, in order to describe the operation of the scanning line driving circuit 130, when timing that is delayed by one cycle of the clock signal Cly from the above timing is set as a reference, periods from the reference by the cycles of 359, 721, 359, 721, 359, 721, 359 and 721 of the clock signal Cly are sequentially and respectively denoted as periods A, B, C, D, E, F, G and H. Here, the sum of the lengths of the periods A and B equals to 1080 cycles of the clock signal Cly. Similarly, the sum of the lengths of the periods C and D, the sum of the lengths of the periods E and F and the sum of the lengths of the periods G and H each equal to 1080 cycles of the clock signal Cly.

The shift register 132 includes the first stage to the 1080th stage unit circuits. The unit circuit of each stage delays an input signal by one cycle of the clock signal Cly and outputs the signal as a shift signal, and then transfers the shift signal to the next stage unit circuit as an input signal. However, the input signal of the first unit circuit is the start pulse Dy that is supplied from the control circuit 10.

An AND circuit 134 is provided in correspondence with each stage (each line). The odd-numbered AND circuits 134 each output logical multiplication of a shift signal of the corresponding stage and the enable signal Enb1 to the scanning line 112 as a scanning signal of that line, and the even-numbered AND circuits 134 each output logical multiplication of a shift signal of the corresponding stage and the enable signal Enb2 to the scanning line 112 as a scanning signal of that line. Here, the scanning signals that are supplied to the first, second, third, fourth, 1079th and 1080th scanning lines 112 are respectively denoted as G1, G2, G3, G4, . . . , G1079 and G1080.

The enable signal Enb1, as shown in FIG. 8, has a cycle that is twice as long as that of the clock signal Cly, and a series of two pulses, each having a slightly narrower length than the length of the half cycle of the clock signal Cly, are output so as to place the timing, at which the clock signal Cly rises from an L level to an H level, in between. In addition, the enable signal Enb2, as shown in the same drawing, is obtained by shifting the phase of the enable signal Enb1 by 180 degrees, and attains an H level exclusively from the enable signal Enb1. Here, in regard to the enable signals Enb1 and Enb2, in a period in which the start pulse Dy is output (attains an H level) one cycle of the clock signal Cly before the start of the above periods A, C, E and G, one pulse of the enable signal Enb2 is output and, then, one pulse of the enable signal Enb1 is output. On the other hand, in a period in which the start pulse Dy is output one cycle of the clock signal Cly before the start of the above periods B, D, F and H, conversely, one pulse of the enable signal Enb1 is output and, then, one pulse of the enable signal Enb2 is output.

As the first start pulse Dy is output one cycle of the clock signal Cly before the start timing of the above period A, the start pulse Dy is sequentially delayed by one cycle of the clock signal Cly and then transferred by the shift register 132. Thus, shift signals Y1, Y2, Y3, Y4, . . . , Y1079, and Y1080 are obtained by sequentially delaying the start pulse Dy by one cycle of the clock signal Cly from the start timing of the period A, as shown in FIG. 8. Note that, because of the transfer of the above start pulse, the period from time at which the shift signal Y1 attains an H level to time at which the shift signal Y1080 attains an L level equals to 1080 cycles of the clock signal Cly.

After the first start pulse Dy is output one cycle of the clock signal Cly before the start timing of the period A, when it reaches timing at which 359 cycles of the clock signal Cly have elapsed (that is, timing of one cycle of the clock signal Cly before the start timing of the period B), the second start pulse Dy is output. Thus, shift signals Y1, Y2, Y3, Y4, . . . , Y1079, and Y1080 are obtained by sequentially delaying the start pulse Dy by one cycle of the clock signal Cly from the start timing of the period B, as shown in FIG. 8.

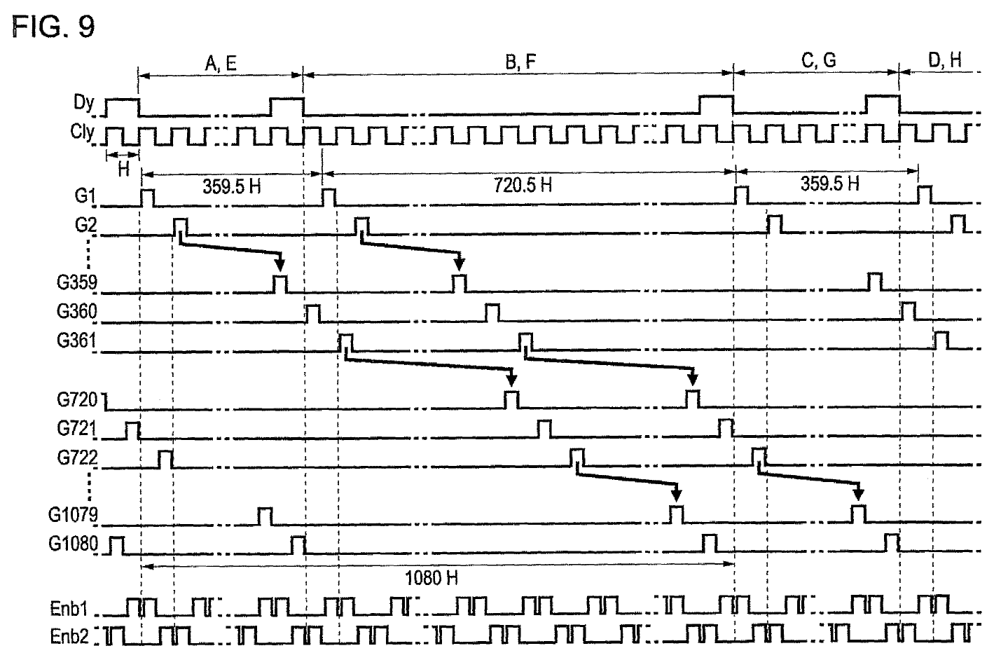

At this time, the first start pulse Dy is being transferred by the unit circuits of the shift register 132. Thus, when the shift signal Y360 attains an H level by the transfer of the first start pulse Dy, the shift signal Y1 attains an H level by the transfer of the second start pulse Dy. Specifically, the shift signals Y360 to Y1080 by the transfer of the first start pulse Dy and the shift signals Y1 to Y721 by the transfer of the second start pulse Dy are output so as to overlap with each other. At this time, the odd-numbered line shift signals and the even-numbered line shift signals overlappingly attain an H level. Thus, even when the pulses of the shift signals overlap each other, the odd-numbered shift signals are taken out by the enable signal Enb1 and the even-numbered shift signals are taken out by the enable signal Enb2 through logical operation of the AND circuits 134 so as not to overlap each other. Thus, as shown in FIG. 9, in regard to the scanning signals supplied to the scanning lines 112, H levels do not overlap each other.

Here, the periods A and B are described; however, the same operation is performed in the periods C and D, the periods E and F and the periods G and H. That is, after the second start pulse Dy is output one cycle of the clock signal Cly before the start timing of the period B, when it reaches timing at which 721 cycles of the clock signal Cly have elapsed (that is, timing of one cycle of the clock signal Cly before the start timing of the period C), the third start pulse Dy is output. Thus, shift signals Y1, Y2, Y3, Y4, . . . , Y1079, and Y1080 are obtained by sequentially delaying the start pulse Dy by one cycle of the clock signal Cly from the start timing of the period C, as shown in FIG. 8. Thus, when the shift signal Y722 attains an H level by the transfer of the second start pulse Dy, the shift signal Y1 attains an H level by the transfer of the third start pulse Dy. In this manner, the shift signals Y721 to Y1080 by the transfer of the second start pulse Dy and the shift signals Y1 to Y359 by the transfer of the third start pulse Dy are output so as to overlap each other.

Because the odd-numbered line scanning signals are shift signals that are taken out by the enable signal Enb1 and the even-numbered line scanning signals are shift signals that are taken out by the enable signal Enb2, scanning signals G1, G2, G3, G4, . . . , G1079 and G1080 are as shown in FIG. 9. Therefore, the scanning lines 112 are selected during the period A (C, E, G) in an interlaced manner in the order of the first, 722nd, second, 723rd, third, 724th, . . . , . . . , 359th and 1080th, and are selected during the period B (D, F, H) in an interlaced manner in the order of the 360th, first, 361st, second, 362nd, third, . . . , 1080th and 721st.

Note that the period that corresponds to the sub-field of each pixel in each row is a period from time when the corresponding scanning line is selected and an on or off voltage is written thereto to time when the corresponding scanning line is selected again. Thus, the periods that correspond to the odd-numbered sub-fields sf1, sf3, sf5 and sf7 are 359.5H. In addition, the periods that correspond to the even-numbered sub-fields sf2, sf4, sf6 and sf8 are 720.5H. Thus, the length of a time period corresponding to each of the odd-numbered sub-fields in each line is shorter by 0.5H and the length of a time period corresponding to each of the even-numbered sub-fields is longer by 0.5H, in comparison with the description of FIG. 3. As a result, there is substantially no influence.

### Data Line Driving Circuit

Next, the data line driving circuit 140 shown in FIG. 1 will be described. The data line driving circuit 140 converts the data Db, which is converted using the conversion table 30, into a voltage of which polarity is specified by the control circuit 10 and then supplies the data line 114 of a column corresponding to the data Db with the voltage as a data signal. Specifically, the data line driving circuit 140, when the data Db converted using the conversion table 30 is “1” that indicates that an on voltage is applied to the liquid crystal element 120, converts the data Db into a voltage Vw(+) when the control circuit 10 specifies positive polarity writing or converts the data Db into a voltage Vw(−) when the control circuit 10 specifies negative polarity writing. On the other hand, the data line driving circuit 140, when the data Db is “0” that indicates that an off voltage is applied to the liquid crystal element 120, converts the data Db into a voltage Vb(+) when the control circuit 10 specifies positive polarity writing or converts the data Db into a voltage Vb(−) when the control circuit specifies negative polarity writing. Note that data signals that are supplied to the first, second, third, 1920th data lines 114 are denoted as data signals d1, d2, d3, . . . , d1920, and the j-th data signal, when the column is not specified, is denoted as dj.

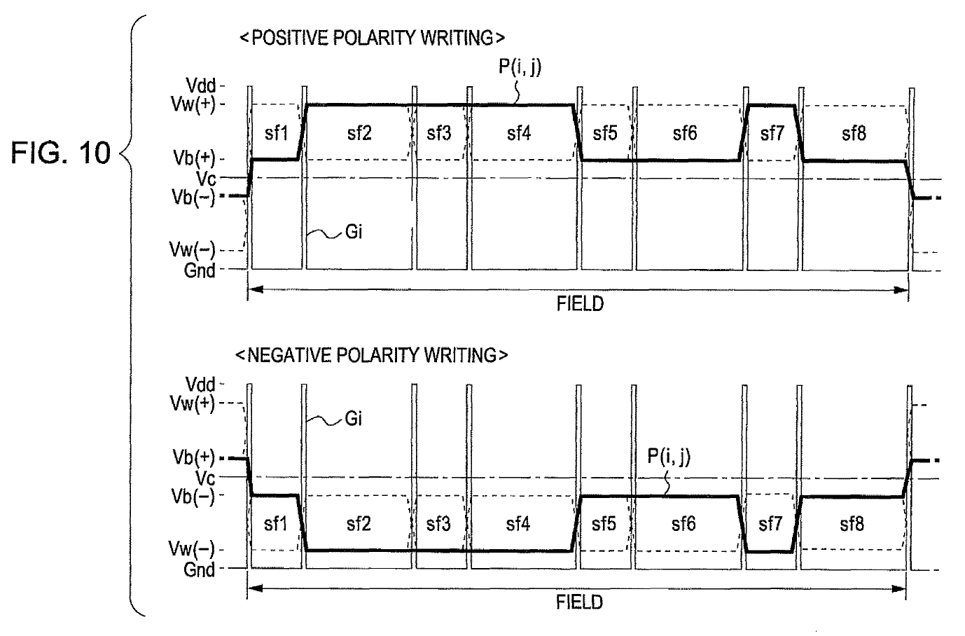

The voltages Vw(+) and Vw(−) are used to apply an on voltage to the liquid crystal element 120 and, as shown in FIG. 10, are symmetrical with respect to the voltage Vc. As described above, in the present embodiment, because the voltage LCcom is applied to the opposite electrode 108, as the voltage Vw(+) is applied to the pixel electrode 118, the liquid crystal element 120 is applied with an on voltage, which is a difference in voltage between the voltage Vw(+) and the voltage LCcom, and, as the voltage Vw(−) is applied to the pixel electrode 118, the liquid crystal element 120 is applied with an on voltage, which is a difference in voltage between the voltage Vw(−) and the voltage LCcom. Note that the on voltage employs a voltage of about 1 to 1.5 times as high as the saturation voltage as described above; however, when the pixel electrode 118 is applied with the voltage Vw(+) or Vw(−), saturation response time, for which the reflectance ratio of the liquid crystal element 120 is saturated to appear white color, is longer than the length of a time period of the shortest sub-field sf1. That is, the length of a time period of the sub-field sf1 is set shorter than the saturation response time of the liquid crystal element 120. On the other hand, the voltages Vb(+) and Vb(−) are used to apply an off voltage to the liquid crystal element 120 and, as shown in FIG. 10, are symmetrical with respect to the voltage Vc. As the voltage Vb(+) is applied to the pixel electrode 118, the liquid crystal element 120 is applied with an off voltage, which is a difference in voltage between the voltage Vb(+) and the voltage LCcom, and, as the voltage Vb(−) is applied to the pixel electrode 118, the liquid crystal element 120 is applied with an off voltage, which is a difference in voltage between the voltage Vb(−) and the voltage LCcom.

Here, as a direct-current component is applied to the liquid crystal element 120, the liquid crystal 105 degrades. Thus, the pixel electrode 118 is alternately applied with a high level side voltage or a low level side voltage with respect to the reference voltage Vc (alternating current driving). In this alternating current driving, writing polarity refers to setting a voltage applied to the pixel electrode 118, that is, setting the voltage of a data signal to a high level side or a low level side with respect to the reference voltage Vc. When the voltage is set to the high level side, it means that the writing polarity is positive polarity. When the voltage is set to the low level side, it means that the writing polarity is negative polarity. Thus, the voltages Vw(+) and Vb(+) are positive polarity voltages, and the voltages Vw(−) and Vb(−) are negative polarity voltages. Note that, in the present embodiment, the written polarity uses the voltage Vc as a reference; however, the voltage uses a ground electric potential Gnd corresponding to the L level of a logic level as a reference of voltage zero, unless otherwise specified.

Incidentally, the voltage LCcom applied to the opposite electrode 108 is set to a slightly lower side than the reference voltage Vc. This is because push down (also referred to as field through, push through) in which the electric potential of the drain (pixel electrode 118) decreases when the n-channel transistor 116 switches from an on state to an off state because of a parasitic capacitance between the gate and drain electrodes occurs. If the voltage LCcom is made to coincide with the reference voltage Vc, the effective voltage value of the liquid crystal element 120 through negative polarity writing is slightly higher than the effective voltage value through positive polarity writing because of push down (when the transistor 116 is of an n-channel type). For this reason, the voltage LCcom is set to an appropriate value that cancels the influence of push down in such a manner that the voltage LCcom is offset to the low level side with respect to the reference voltage Vc. However, when the influence of push down may be ignored, the voltage LCcom and the reference voltage Vc are set to coincide with each other.

Note that, in the present embodiment, the control circuit 10 is configured to alternately switch writing polarity, between positive polarity and negative polarity, applied to the data line driving circuit 140 in each period of one field. Here, as writing polarity is switched in every field, it is so-called surface inversion driving. However, in the present embodiment, because the liquid crystal element 120 is driven in a saturation region, that is, with any one of an off voltage that is equal to or lower than the optical threshold value or an on voltage that is equal to or higher than the optical saturation voltage, even when a switching cycle is 16.7 milliseconds, the switching is not recognized as a flicker.

### Writing Operation

Next, the display operation of the electro-optical device 1 will be described. The control circuit 10 supplies the start pulse Dy, the clock signal Cly, the enable signals Enb1 and Enb2 to the scanning line driving circuit 130, as described above, and the scanning line driving circuit 130 supplies scanning signals to the scanning lines 112 in accordance with these signals. Thus, the control circuit 10 indirectly controls selection of the scanning line.

As described above, in the period A, the scanning lines 112 are scanned in an interlaced manner in the order of the first, 722nd, second, 723rd, third, 724th, . . . , . . . , 359th and 1080th. When the first, second, third, . . . , 359th scanning lines are selected, writing of an on or off voltage is performed in the sub-field sf1, while, on the other hand, when the 722nd, 723rd, 724th, . . . , 1080th scanning lines are selected, writing of an on or off voltage is performed in the sub-field sf8 of the preceding field.

The control circuit 10, before selecting the first scanning line 112 in the period A, reads out the display data Da of the first row pixels in the first to 1920th columns from the memory 20 and supplies the display data Da to the conversion table 30. In this manner, the conversion table 30 sequentially converts the read display data Da into a gray-scale level, which is specified by the display data Da, and the data Db corresponding to the sub-field sf1. For example, when the read display data Da are data to which the gray-scale level “9” is to be specified, in correspondence with the sub-field sf1, the display data Da are converted into “0” by which an off voltage is applied to the liquid crystal element 120 (see FIG. 6). Note that, in the present embodiment as described above, writing polarity is alternately switched between positive polarity and negative polarity in each period of one field. Here, in this one field, it is assumed that positive polarity writing is specified.

The data line driving circuit 140 stores one line data Db corresponding to the converted first row and first column to the first row and 1920th column. After that, when the first scanning signal G1 attains an H level, the data line driving circuit 140 converts the data Db to the voltage Vw(+) when the data Db is “1” and converts the data Db to the voltage Vb(+) when the data Db is “0”. Thereafter, the data line driving circuit 140 supplies the voltages to the first to 1920th data lines 114 as data signals d1 to d1920. For example, when the first row and j-th column data Db is “0”, the data signal dj is converted into the voltage Vb(+) when the scanning signal G1 attains an H level.

As the first scanning signal G1 attains an H level, the transistors 116 of the pixels 110 located in the first row all enter an on state. Thus, the voltage of the data signal supplied to each of the data lines 114 is applied to the pixel electrode 118. Therefore, for the liquid crystal elements 120 of the first row pixels in the first, second, third, fourth, . . . , 1920th columns, the positive polarity voltage Vw(+) corresponding to an on state or the positive polarity voltage Vb(+) corresponding to an off state, specified by the data Db, is applied to each of the pixel electrodes and, then, a voltage difference with respect to the voltage LCcom applied to the opposite electrode 108 is written. Here, in the liquid crystal element 120 in which the pixel electrode 118 is applied with the voltage Vw(+), a voltage difference with respect to the voltage LCcom becomes an on voltage, while, in the liquid crystal element in which the voltage Vb(+) is applied, a voltage difference with respect to the voltage LCcom becomes an off voltage. Even when the transistor enters an off state, the voltage difference is held owing to its capacitive property until the transistor 116 enters an on state next time and then a data signal is applied to the pixel electrode. In the first scanning line 112, the transistors 116 enter an on state next time when the scanning line is selected by the transfer, or the like, of the second start pulse Dy, that is 359.5H later. Thus, an on or off voltage that is written this time will be held for the period of the sub-field sf1.

In the period A, the 722nd scanning line 112 is selected next, and this selection is performed in order to write an on or off voltage in the sub-field sf8 of the preceding field. Therefore, the control circuit 10, before selecting the 722nd scanning line 112 in the period A, reads out the display data Da of the 722nd row pixels in the first to 1920th columns from the memory 20 and supplies the display data Da to the conversion table 30. The conversion table 30 sequentially converts the read display data Da into the gray-scale level, which is specified by the display data Da, and the data Db corresponding to the sub-field sf8. Here, because negative polarity writing is specified in the preceding field, the data line driving circuit 140 stores one line data Db corresponding to the converted 722nd row and first column to the 722nd row and 1920th column. After that, when the 722nd scanning signal G722 attains an H level, the data line driving circuit 140 converts the data Db to the voltage Vw(−) when the data Db is “1” and converts the data Db to the voltage Vb(−) when the data Db is “0”. Thereafter, the data line driving circuit 140 supplies the voltages to the first to 1920th data lines 114 as data signals d1 to d1920. As the scanning signal G722 attains an H level, for the liquid crystal elements 120 of the 722nd row pixels in the first, second, third, fourth, . . . , 1920th columns, the negative polarity voltage Vw(−) corresponding to an on state or the negative polarity voltage Vb(−) corresponding to an off state, specified by the data Db, is applied to each of the pixel electrodes and, then, a voltage difference with respect to the voltage LCcom is written. Here, in the liquid crystal element 120 in which the pixel electrode 118 is applied with the voltage Vw(−), a voltage difference with respect to the voltage LCcom becomes an on voltage, while, in the liquid crystal element in which the voltage Vb(−) is applied, a voltage difference with respect to the voltage LCcom becomes an off voltage. Even when the transistor 116 enters an off state, the voltage difference is held owing to its capacitive property until the transistor 116 enters an on state next time and then a data signal is applied to the pixel electrode. In the 722nd scanning line 112, the transistors 116 enter an on state next time when the scanning line is selected by the transfer, or the like, of the first start pulse Dy, that is 720.5H later. Thus, an on or off voltage that is written this time will be held for the period of the sub-field sf8.

In the period A, the second scanning line is selected next, and this selection is performed in order to write an on or off voltage in the sub-field sf1 as in the case of the first scanning line. Thus, as in the case of the first row pixels, a positive polarity on or off voltage corresponding to the gray-scale level and the sub-field sf1, which are specified by the display data Da of the second row and first column to the second row and 1920th column, is written to each of the liquid crystal elements 120 of the second row pixels, and is held for the period of the sub-field sf1. In the period A, the 723rd scanning line is selected next, and this selection is performed in order to write an on or off voltage in the sub-field sf8 as in the case of the 722nd scanning line. Thus, as in the case of the 722nd row pixels, a negative polarity on or off voltage corresponding to the gray-scale level and the sub-field sf8, which are specified by the display data Da of the 723rd row and first column to the 723rd row and 1920th column, is written to each of the liquid crystal elements 120 of the 723rd row pixels, and is held for the period of the sub-field sf8. In the period A, thereafter, similarly, the scanning lines 112 are selected in the order of the third, 724th, fourth, 725th, . . . , 359th and 1080th. Then, a positive polarity on or off voltage corresponding to the gray-scale level and the sub-field sf1 is written to each of the liquid crystal elements 120 of the third, fourth, . . . , 359th pixels and is held for the period of the sub-field sf1, while, on the other hand, a negative polarity on or off voltage corresponding to the gray-scale level and the sub-field sf8 is written to each of the liquid crystal elements 120 of the 724th, 725th, . . . , 1080th pixels and is held for the period of the sub-field sf8.

Subsequently, it proceeds to the period B. In the period B, the scanning lines 112 are scanned in an interlaced manner in the order of the 360th, first, 361st, second, 362nd, third, . . . , . . . , 1080th and 721st. When the 360th, 361st, 362nd, . . . , . . . , 1080th scanning lines are selected, writing of an on or off voltage is performed in the sub-field sf1, while, on the other hand, when the first, second, third, . . . , 721st scanning lines are selected, writing of an on or off voltage is performed in the sub-field sf2. Note that writing in the sub-fields sf1 and sf2 is all positive polarity writing because they belong to the same field. The period from time when the 360th, 361st, 362nd, . . . , 1080th scanning lines are selected to time when they are selected next time is 359.5H. Therefore, an on or off voltage that is written by selection of the 360th, 361st, 362nd, . . . , 1080th scanning lines is held for the period of sub-field sf1. On the other hand, the period from time when the first, second, third, . . . , 721st scanning lines are selected to time when they are selected next time is 720.5H. Therefore, an on or off voltage that is written by selection of the first, second, third, . . . , 721st scanning lines is held for the period of the sub-field sf2.

Subsequently, it proceeds to the period C. In the period C, as in the case of the period A, the scanning lines 112 are scanned in an interlaced manner in the order of the first, 722nd, second, 723rd, third, 724th, . . . , 359th and 1080th. When the first, second, third, . . . , 359th scanning lines are selected, writing of an on or off voltage is performed in the sub-field sf3 and is held for the period of the sub-field sf3, while, on the other hand, when the 722nd, 723rd, 724th, . . . , 1080th scanning lines are selected, writing of an on or off voltage is performed in the sub-field sf2 and is held for the period of the sub-field sf2. In the period D, as in the case of the period B, the scanning lines 112 are scanned in an interlaced manner in the order of the 360th, first, 361st, second, 362nd, third, . . . , 1080th and 721st. When the 360th, 361st, 362nd, . . . , . . . , 1080th scanning lines are selected, writing of an on or off voltage is performed in the sub-field sf3 and is held for the period of the sub-field sf3, while, on the other hand, when the first, second, third, . . . , 721st scanning lines are selected, writing of an on or off voltage is performed in the sub-field sf4 and is held for the period of the sub-field sf4.

In this manner, it sequentially proceeds in the order of the periods E, F, G and H. Then, in the period E (or G), as in the case of the period A, the scanning lines 112 are scanned in an interlaced manner in the order of the first, 722nd, second, 723rd, third, 724th, . . . , 359th and 1080th. When the first to 359th scanning lines are selected, writing of an on or off voltage is performed in the sub-field sf5 (or sf7) and is held for the period of the sub-field sf5 (or sf7), while, on the other hand, when the 722nd to 1080th scanning lines are selected, writing of an on or off voltage is performed in the sub-field sf4 (or sf6) and is held for the period of the sub-field sf4 (or sf6). Then, in the period F (or H), as in the case of the period B, the scanning lines 112 are scanned in an interlaced manner in the order of the 360th, first, 361st, second, 362nd, third, . . . , . . . , 1080th and 721st. When the 360th to 1080th scanning lines are selected, writing of an on or off voltage is performed in the sub-field sf5 (or sf7) and is held for the period of the sub-field sf5 (or sf7), while, on the other hand, when the first to 721st scanning lines are selected, writing of an on or off voltage is performed in the sub-field sf6 (or sf8) and is held for the period of the sub-field sf6 (or sf8).

After the period H, it returns to the period A again. At this time, when the 722nd to 1080th scanning lines are selected in the period A, writing of an on or off voltage is performed in the sub-field sf8, so that it is positive polarity writing. However, because negative polarity writing is specified in the first to 359th scanning lines, the voltage Vw(−) is written and held in each of the liquid crystal elements 120 when the converted data Db is “1” and the voltage Vb(−) is written and held in each of the liquid crystal elements 120 when the converted data Db is “0”.

FIG. 10 is a view that shows a voltage P(i, j) of the pixel electrode 118 in the i-th row and j-th column liquid crystal element 120. As described above, when positive polarity writing is specified, the voltage P(i, j) is any one of the voltage Vw(+) that applies an on voltage to the liquid crystal element or the voltage Vb(+) that applies an off voltage to the liquid crystal element when the scanning line G1 attains an H level and is held for the period of each sub-field. In addition, when negative polarity writing is specified, the voltage P(i, j) is any one of the voltage Vw(−) that applies an on voltage or the voltage Vb(−) that applies an off voltage when the scanning signal G1 attains an H level and is held for the period of each sub-field.

Note that the example shown in FIG. 10 shows the case in which the gray-scale level “9” is specified to the i-th row and j-th column pixel. As shown in FIG. 4 or FIG. 6, when the gray-scale level “9” is specified, an on voltage is applied in the sub-fields sf2 to sf4 and sf7 and an off voltage is applied in the other sub-fields. Thus, in FIG. 10, when positive polarity writing is specified, the voltage P(i, j) becomes the voltage Vw(+) over a period corresponding to the sub-fields sf2 to sf4 and sf7 and becomes the voltage Vb(+) over a period corresponding to the sub-fields sf1, sf5, sf6 and sf8. On the other hand, when negative polarity writing is specified, the voltage P(i, j) becomes the voltage Vw(−) over a period corresponding to the sub-fields sf2 to sf4 and sf7 and becomes the voltage Vb(−) over a period corresponding to the sub-fields sf1, sf5, sf6 and sf8.

FIG. 11A is a view that shows the progress of selection of the first to 1080th scanning lines in one field. In the drawing, selection of the scanning lines is shown with small dots; however, because the scanning lines are selected toward the lower side over time, the small dots are shown as solid lines that are continuous to the right lower direction. In addition, FIG. 11B and FIG. 11C are views, each of which shows the state of the pixels in the display circuit 100. Because the scanning lines, to which an on or off voltage is written in the same sub-field, are selected in the order from the first to the 1080th, the pixels, for which selection of the corresponding scanning line has been completed, are located on the upper side with respect to the scanning line to be selected.

Thus, as shown in FIG. 11A, for example, in the period B, writing for the sub-field sf2 is performed in the first to 721st scanning lines, and writing for the sub-field sf1 is performed in the 360th to 1080th scanning lines. Thus, at timing T1 in the period B, the pixels of the display circuit 100, as shown in FIG. 11B, are classified into a state in which an on or off voltage written in the sub-field sf2 is held, a state in which an on or off voltage written in the sub-field sf1 is held and a state in which an on or off voltage written in the sub-field sf8 of the preceding field is held, for each of the regions that are tripartitioned along the scanning lines in association with writing. In addition, as shown in FIG. 11A, for example, in the period G, writing for the sub-field sf7 is performed in the first to 359th scanning lines, and writing for the sub-field sf6 is performed in the 722nd to 1080th scanning lines. Thus, at timing T2 in the period G, the pixels of the display circuit 100, as shown in FIG. 11C, are classified into a state in which an on or off voltage written in the sub-field sf7 is held, a state in which an on or off voltage written in the sub-field sf6 is held and a state in which an on or off voltage written in the sub-field sf5 of the preceding field is held, for each of the regions that are tripartitioned along the scanning lines in association with writing.

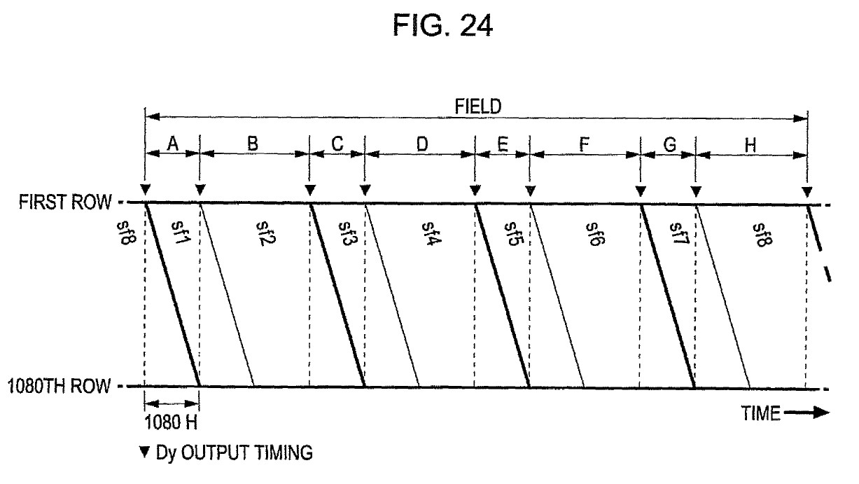

In the present embodiment, the scanning lines are scanned in an interlaced manner in part of the period of each sub-field. In order to describe the advantage of this configuration, the progress of writing in the configuration in which interlaced scanning is not performed will be described with reference to FIG. 24. When the scanning lines 112 are sequentially selected from the first to the 1080th to write an on or off voltage in each sub-field in an non-interlaced manner, the scanning line driving circuit 130 is configured so that the AND circuits 134 shown in FIG. 7 are omitted and the shift signals Y1 to Y1080 are supplied as the scanning signals G1 to G1080 as it is. However, in this configuration, it is necessary to set a period, which is required to sequentially select the scanning lines from the first to the 1080th, equal to or shorter than a period corresponding to the shortest odd-numbered sub-field sf1 (sf3, sf5, sf7). That is, the period from time when the shift signal Y1 changes from an L level to an H level because of the transfer of the start pulse Dy to time when the scanning line Y1080 changes from an H level to an L level is 1080 cycles of the clock signal Cly. Thus, the period should be set at least equal to or shorter than the period of the odd-numbered sub-field sf1 (sf3, sf5, sf7) that has a ratio of “1”. When the 1080 cycles of the clock signal Cly are made to coincide with the period of the odd-numbered sub-field sf1 (sf3, sf5, sf7), one field, which has a ratio of “12”, has 12960 (=1080×12) cycles. In this configuration, because one cycle of the clock signal Cly corresponds to a period required to select the scanning line once, selection of one line takes a period that corresponds to one 12960th of the period (16.7 milliseconds) of one field. As a result, a sufficient writing period cannot be ensured. In addition, when the number of addressable luminance levels that can be displayed is increased or improvement of the gray scale characteristic is attempted, one field is further divided into multiple sub-fields and the period of each sub-filed needs to be set shorter. However, in the non-interlaced scanning, it is understandable that such setting is also difficult.

On the other hand, in the present embodiment, because selection of one scanning line is achieved by splitting an overlapped shift signal with two enable signals, the period required to select the scanning line once is approximately a half of one cycle of the clock signal Cly. However, in the present embodiment, as shown in FIG. 11A, for the first to 1080th scanning lines, writing of an on or off voltage to the two sub-fields is made to progress in parallel through interlaced scanning. Thus, one field is just 4320 (=1080×4) cycles of the clock signal Cly. Accordingly, in the present embodiment, selection of one line takes a period that corresponds to one 8640th of the period of one field, and, in comparison with the case of non-interlaced scanning, it is possible to ensure a writing period. In addition, it is understandable that it is possible to cope with the case in which the number of addressable luminance levels that can be displayed is increased or in which improvement of the gray scale characteristic is attempted.

### First Application and Modification of First Embodiment

In the above described first embodiment, the enable signal Enb1 is supplied to one of input ends of each odd-numbered AND circuit 134 and the enable signal Enb2 is supplied to one of input ends of each even-numbered AND circuit 134. The reason why the above configuration is employed is as follows. That is, by sequentially shifting the start pulse Dy using the shift register 132, the odd-numbered and even-numbered shift signals become an H level pulse at the same time. The pulse is taken out by the enable signal Enb1 in each odd-numbered line and is taken out by the enable signal Enb2 in each even-numbered line through logical operation to thereby make the scanning signal be not at an H level overlappingly. That is, in the first embodiment, two shift signals are allowed to overlappingly become an H level, and the shift signals are taken out so as not to overlap between in the odd-numbered lines and in the even-numbered lines to thereby obtain scanning signals. Developing the above configuration, for example, S shift signals are allowed to overlappingly become an H level, and the shift signals are taken out so as not to overlap among in the mutually different S lines to thereby obtain scanning signals.

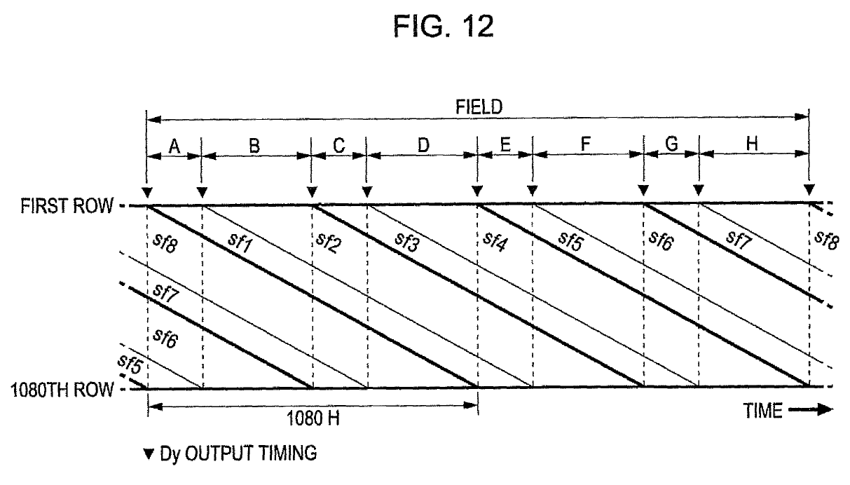

For example, the case in which S is set to “4”, and four shift signals, of which H levels are overlapped, are taken out with first to fourth series enable signals to obtain scanning signals will be considered. Here, the first series indicates lines of which remainder is “1” when the line numbers of the first to 1080th lines are divided by 1411, and, specifically, indicates the lines corresponding to the first, fifth, ninth, . . . , 1077th scanning lines 112. Similarly, the second, third and fourth series indicate lines of which remainders are respectively “2”, “3”, “0” when the line numbers of the first to 1080th lines are divided by “4”. The second series indicates the lines corresponding to the second, sixth, tenth, . . . , 1078th scanning lines 112. The third series indicates the lines corresponding to the third, seventh, eleventh, . . . , 1079th scanning lines 112. The fourth series indicates the lines corresponding to the fourth, eighth, twelfth, and 1080th scanning lines 112. In this manner, when the first to forth series enable signals are used, it is possible to output the scanning signals, of which H levels are not overlapped, from four shift signals of which H levels are overlapped. Therefore, it is possible to make writing of an on or off voltage in each sub-field progress as shown, for example, in FIG. 12.

### Second Application and Modification of First Embodiment

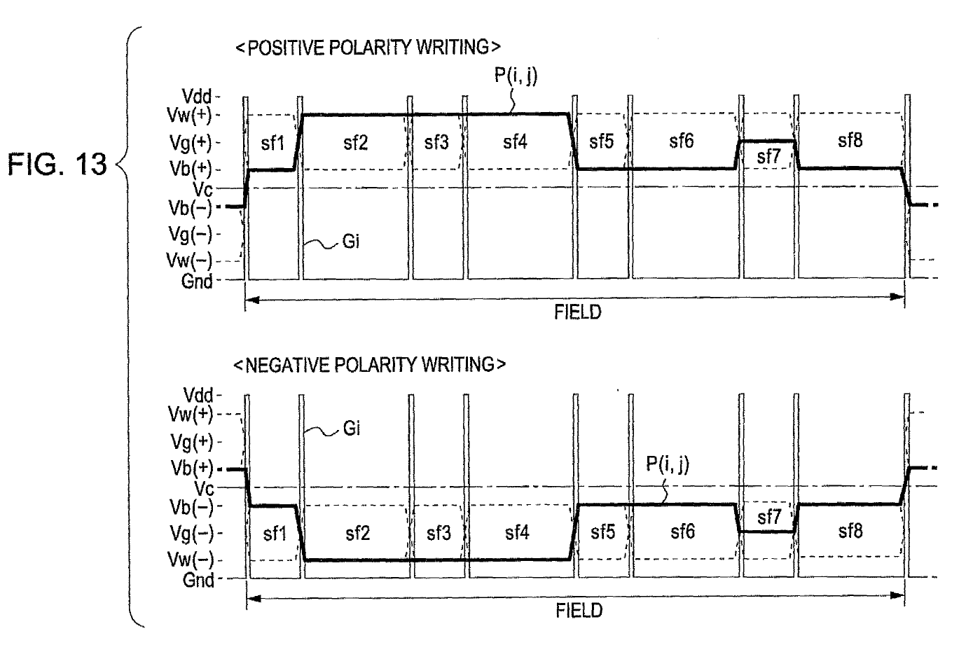

In the first embodiment, any one of an on voltage or an off voltage is applied to the liquid crystal elements 120 in each of the sub-fields sf1 to sf8; however, an intermediate (half) voltage may be added in addition to choices of an on voltage and an off voltage. Note that the half voltage, for example, as shown in FIG. 13, is Vg(+), which is an intermediate voltage between the voltage Vw(+) and the voltage vb(+) when positive polarity writing is specified, and is Vg(−), which is an intermediate voltage between the voltage Vw(−) and the voltage Vb(−) when negative polarity writing is specified. In addition, actually, a sub-field to which a half voltage is allocated will be selected in consideration of the actual reflectance ratio characteristics of the liquid crystal element 120 with respect to gray-scale levels.

In the first embodiment, when the gray-scale level “9” is set, an on voltage is applied in the sub-fields sf2 to sf4 and sf7, and an off voltage is applied in the other sub-fields sf1, sf5, sf6 and sf8. Here, the gray-scale level “8” that is one level darker than the gray-scale level “9” is such that the sub-field sf7, to which an on voltage is applied in the gray-scale level “9”, is changed to be applied with an off voltage. Thus, in order to achieve a gray-scale level between the gray-scale level 119 and the gray-scale level “8”, it is only necessary to, for example, apply a half voltage in the sub-field sf7. FIG. 13 is a view that indicates a voltage P(i, j) of the pixel electrode 118 when the gray-scale level is specified between the gray-scale level “8” and the gray-scale level “9” in the i-th row and j-th column liquid crystal element 120.

Thus, a half voltage is further added to an on voltage and an off voltage as a voltage to be applied to the liquid crystal element 120 in the sub-fields sf1 to sf8, so that it is possible to achieve multiple gray scales without changing the configuration of sub-fields. Note that a half voltage employs one type, that is, an intermediate voltage between an on voltage and an off voltage; however, for example, the intermediate voltage may, for example, employ two types, that is, 33% and 66% of an on voltage, or employ three types, that is, 25%, 50% and 75% of an on voltage, or the like, to achieve further multiple gray scales.

### Third Application and Modification of First Embodiment

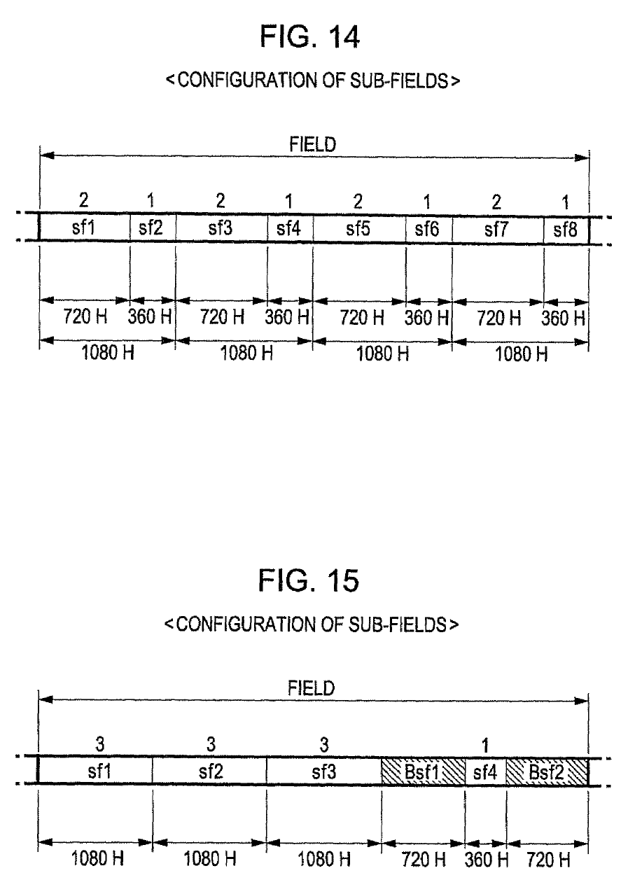

In the above embodiment, the ratio of the length of a time period of each odd-numbered sub-fields sf1, sf3, sf5 or sf7 is set to “1”, and the ratio of the length of a time period of each even-numbered sub-field sf2, sf4, sf6 or sf8 is set to “2”; however, the ratios of them may be interchanged as shown in FIG. 14. In addition, the ratio of the length of a time period of each sub-field may be selectively set by taking the actual reflectance ratio characteristics of the liquid crystal element 120 into consideration. Furthermore, in the first embodiment, p is set to “4”, one field is equally divided into four groups and then one group is divided into an odd-numbered sub-field and an even-numbered sub-field; however, it is applicable that one field is not divided into groups and, in addition, the ratio of the length of a time period of each sub-field is selectively set by taking the actual reflectance ratio characteristics of the liquid crystal element 120 into consideration. That is, it is only necessary that one field is divided into a sub-field of which the length of a time period is relatively short and a sub-field of which the length of a time period is relatively long.

When the ratio of the length of a time period of each sub-field is changed, and two series enable signals Enb1 and Enb2, as shown in FIG. 7, are used, the 1080 cycles of the clock signal Cly are set equal to or shorter than a period that combines continuous two sub-fields, of which the sum of the lengths of time periods is the shortest. Note that, in the example shown in FIG. 3, because the sum of the lengths of time periods of the continuous two sub-fields is all the same, and the sum is set to coincide with the 1080 cycles of the clock signal Cly. In addition, in the configuration that uses four series enable signals, the 1080 cycles of the clock signal Cly are set equal to or shorter than a period that combines continuous four sub-fields, of which the sum of the lengths of time periods is the shortest. In any cases, it is only necessary to supply the start pulse Dy to the scanning line driving circuit 130 (first stage of the shift register 132) at time intervals corresponding to a set period of each sub-field.

### Second Embodiment

As described above, in terms of improving the gray scale characteristics, it is important to appropriately apply an on or off voltage to the liquid crystal element 120 of each pixel over a sub-field of which the period is set the shortest. Thus, in the first embodiment, the scanning lines are scanned in an interlaced manner (region scanning driving) in the short sub-fields in order to appropriately apply an on or off voltage to the liquid crystal element 120. In contrast, in the second embodiment, the scanning lines are scanned in a non-interlaced manner in such a manner that an off voltage is forcibly applied to the liquid crystal element 120 by selecting an erasing scanning line when the period of the sub-field has elapsed after an on or off voltage is applied to the liquid crystal element 120 in a short sub-field.

FIG. 15 is a view that shows the configuration of sub-fields according to the second embodiment. As shown in the drawing, in the second embodiment, the period of one field includes sub-fields sf1 to sf3, of which the length of a time period is 1080H, and a sub-field sf4, of which the length of a time period is 360H that is shorter than the above sub-fields. In addition, in the present embodiment, a blank sub-field Bsf1 and a blank sub-field Bsf2 are respectively arranged on the preceding side and on the following side in terms of time so as to place the sub-field sf4 in between. Here, in the blank sub-fields Bsf1 and Bsf2, the liquid crystal element 120 is always applied with an off voltage. Thus, in the second embodiment, the highest gray scale may be achieved by applying an on voltage in all the sub-fields sf1 to sf4, and the gray scale that is one level darker than the highest gray scale may be achieved by changing an on voltage to an off voltage in the sub-field sf4. In addition, the lowest gray scale may be achieved by applying an off voltage in all the sub-fields sf1 to sf4, and the gray scale that is one level brighter than the lowest gray scale may be achieved by changing an off voltage to an on voltage in the sub-field sf4. Note that, in regard to the other gray scales, applying an on or off voltage in each of the sub-fields sf1 to sf4 may be determined by taking the actual reflectance ratio characteristics of the liquid crystal element 120 into consideration, so that the description thereof is omitted.

The overall configuration of the electro-optical device in the second embodiment is the same as that of FIG. 1. However, signals output from the control circuit 10, the pixels 110 and the scanning line driving circuit 130 are partly different from those of the first embodiment. Therefore, for the second embodiment, description will be made around these different points.

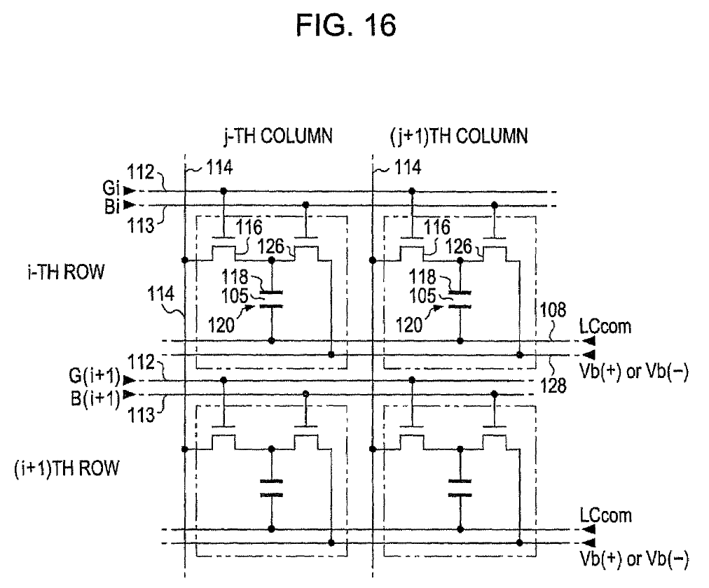

FIG. 16 is a view that shows the configuration of pixels in the second embodiment. The pixels 110 shown in the drawing differ from those shown in FIG. 2 in that an erasing scanning line 113 and a power supply line 128 are provided in correspondence with the scanning line 112 of each line, and each pixel 110 includes an n-channel transistor 126. Because the first to 1080th scanning lines 112 are provided, the first to 1080th erasing scanning lines 113 are also provided as well. The first to 1080th erasing scanning lines 113 are respectively supplied with erasing scanning signals B1 to B1080 from the scanning line driving circuit, which will be described later. In the i-th row and j-th column pixel 110, the gate electrode of the transistor 126 is connected to the i-th erasing scanning line 113, the source electrode thereof is connected to the power supply line 128 and the drain electrode thereof is connected to the pixel electrode 118.

Here, the i-th power supply line 128 is supplied with a voltage that forcibly makes a voltage, which is held in the liquid crystal element 120 over the sub-fields sf3 and sf4, be an off voltage when the i-th erasing scanning signal Bi is at an H level in order to obtain the blank fields Bsf1 and Bsf2. That is, the i-th power supply line 128 is supplied with the voltage Vb(+) when the erasing scanning signal Bi is at an H level in a case where an on voltage or an off voltage is held over the sub-fields sf3 and sf4 by applying the positive polarity voltage Vw(+) or Vb(+) to the pixel electrode 118 of each i-th liquid crystal element 120 or is supplied with the voltage Vb(−) when the erasing scanning signal Bi is at an H level in a case where an on voltage or an off voltage is held over the sub-fields sf3 and sf4 by applying the negative polarity voltage Vw(−) or Vb(−).

As the erasing scanning signal Bi supplied to the i-th erasing scanning line 113 attains an H level, the transistors 126 of the first to 1920th column pixels 110 located in the i-th row all enter an on state. Thus, each of the pixel electrodes 118 is applied with the voltage Vb(+) or vb(−), so that each of the liquid crystal elements 120 is forcibly applied with an off voltage. Therefore, as the erasing scanning signal Bi is at an H level due to in the blank sub-field Bsf1, the i-th row liquid crystal elements 120 hold an off voltage until the scanning signal G1 attains an H level due to in the sub-field sf4. Similarly, as the erasing scanning signal Bi is at an H level due to in the blank sub-field Bsf2, the i-th row liquid crystal elements 120 hold an off voltage until the scanning signal G1 attains an H level due to in the sub-field sf1.

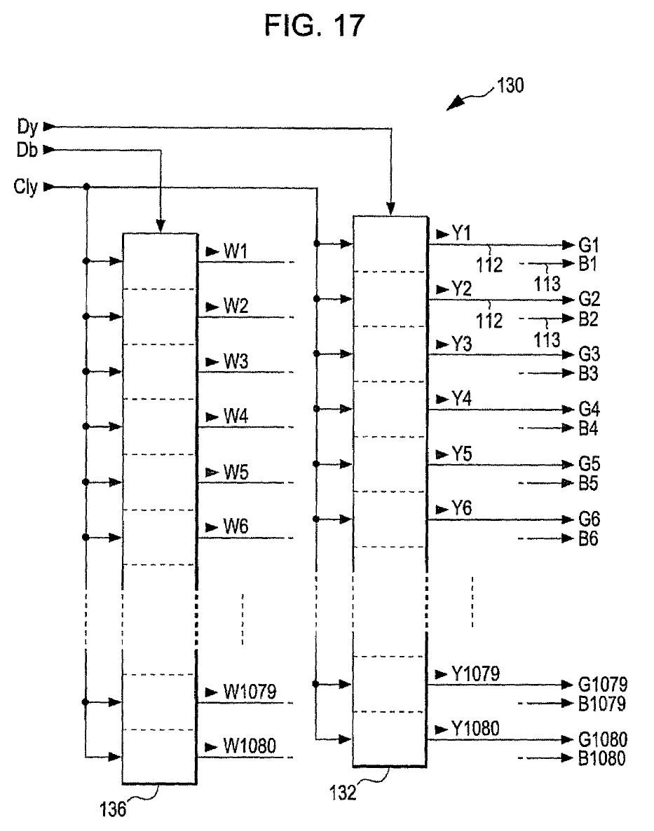

Next, the scanning line driving circuit 130 in the second embodiment will be described with reference to FIG. 17. As shown in the drawing, the scanning line driving circuit 130 includes no AND circuit 134 (see FIG. 7), which is provided in the case of the first embodiment, and the shift signals Y1 to Y1080 of the shift register 132 are respectively supplied to the first to 1080th scanning lines 112 as it is as the scanning signals G1 to G1080. In addition, the shift register 136, as in the case of the shift register 132, includes the first stage to the 1080th stage unit circuits. The unit circuit of each stage delays an input signal by one cycle of the clock signal Cly and outputs the signal as a shift signal, and then supplies the shift signal to the next stage unit circuit as an input signal. Shift signals W1 to W1080 of the shift register 136 are respectively supplied to the first to 1080th erasing scanning lines 113 as it is as erasing scanning signals B1 to B1080. Note that an input signal of the first stage unit circuit in the shift register 136 is a start pulse Db supplied from the control circuit 10.

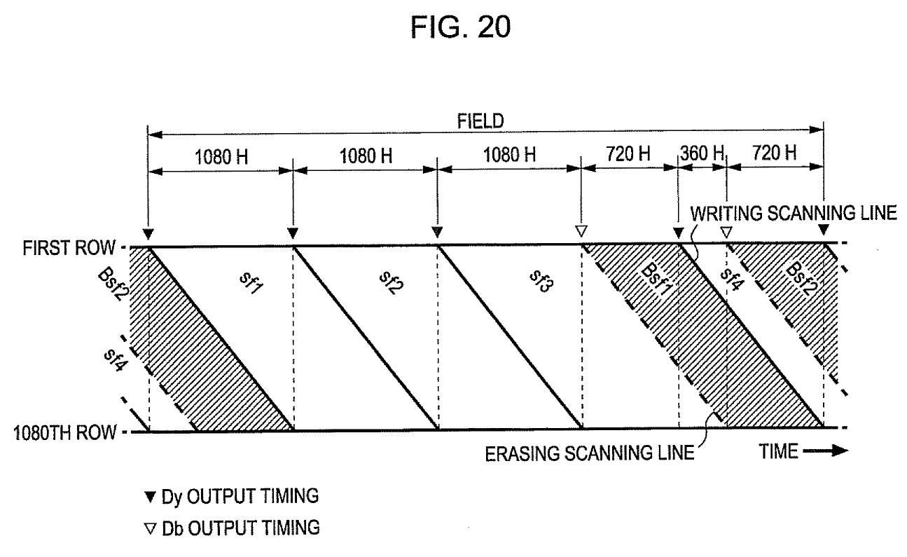

In the second embodiment, the control circuit 10 outputs the start pulses Dy and Db, as shown in FIG. 20. Specifically, as shown in the drawing, in order to scan the scanning lines in the sub-field sf1 of a field, the control circuit 10 outputs the first start pulse Dy, outputs the second start pulse Dy when the 1080 cycles of the clock signal Cly have elapsed, outputs the third start pulse Dy when the 1080 cycles of the clock signal Cly have elapsed, outputs the first start pulse Db when the 1080 cycles of the clock signal Cly have elapsed, outputs the fourth start pulse Dy when the 720 cycles of the clock signal Cly have elapsed and outputs the second start pulse Db when the 360 cycles of the clock signal Cly have elapsed. After that, the control circuit 10, when the 720 cycles of the clock signal Cly have elapsed, will output the first start pulse Dy again in order to scan the scanning lines in the sub-field sf1 of the next field.

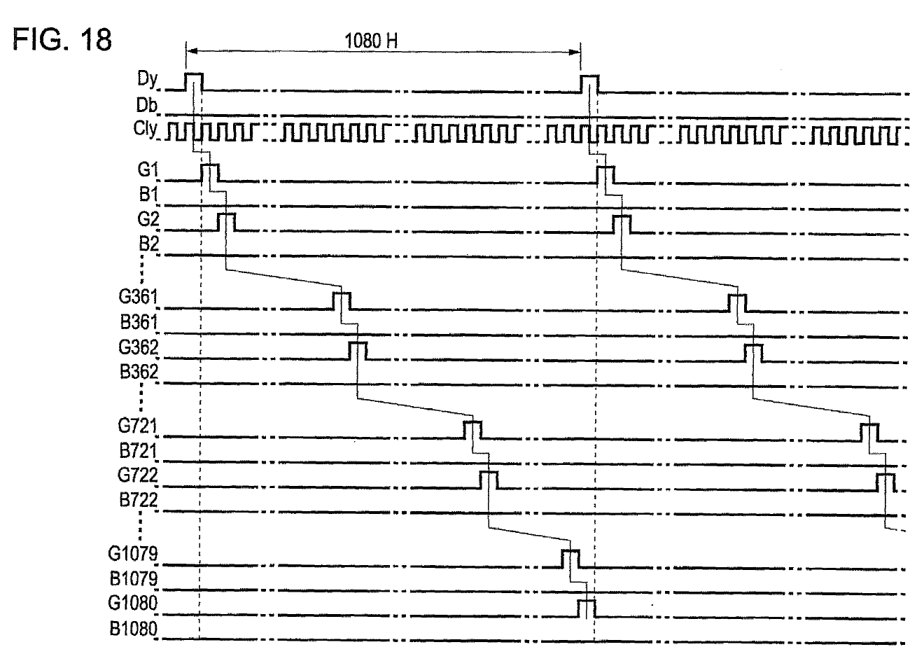

As the first start pulse Dy is supplied from the control circuit 10 to the shift register 132, as shown in FIG. 18, the shift signals generated by the shift register 132, that is, the scanning signals G1, G2, G3, . . . , G1080, are obtained by sequentially delaying the first start pulse Dy by one cycle of the clock signal Cly. Here, for example, when the i-th scanning signal G1 attains an H level, the data signal dj supplied to the j-th data line 114 has a gray-scale level specified to the i-th row and j-th column pixel and a voltage that applies an on or off voltage to the liquid crystal element 120 in accordance with the sub-field sf1, that is, the voltage Vw(+) or Vb(+) when positive polarity writing is specified. Note that, when the scanning lines G1 to G360 sequentially attain an H level by the transfer of the first start pulse Dy, the erasing scanning signals B721 to B1080 also sequentially attain an H level by the transfer of the second start pulse Db in the preceding field. The operation caused by the erasing scanning signals B721 to B1080 will be described later.

Next, when the 1080 cycles of the clock signal Cly have elapsed since the first start pulse Dy was output, the second start pulse Dy is supplied to the shift register 132. Thus, the scanning signals G1, G2, G3, . . . , G1080 are obtained by sequentially delaying the first start pulse Dy by one cycle of the clock signal Cly by the shift register 132. Here, when the scanning signal G1 attains an H level, the data signal dj has a gray-scale level specified to the i-th row and j-th column pixel and a voltage that applies an on or off voltage to the liquid crystal element 120 in accordance with the sub-field sf2. In addition, in the i-th line, voltages that are written to the liquid crystal elements 120 when the scanning signal G1 attains an H level by the transfer of the first start pulse Dy will be updated when the scanning signal G1 attains an H level by the transfer of the second start pulse Dy. Thus, the voltages that are written to the liquid crystal elements 120 when the scanning signal G1 attains an H level by the transfer of the first start pulse Dy are held over a period of 1080H corresponding to the sub-field sf1.

When the 1080 cycles of the clock signal Cly have elapsed since the second start pulse Dy was output, the third start pulse Dy is supplied to the shift register 132, while the scanning signals G1, G2, G3, . . . , G1080 are obtained by sequentially delaying the third start pulse Dy by one cycle of the clock signal Cly. Here, when the scanning signal G1 attains an H level, the data signal dj has a gray-scale level specified to the i-th row and j-th column pixel and a voltage that applies an on or off voltage to the liquid crystal element 120 in accordance with the sub-field sf3. In addition, in the i-th line, voltages that are written to the liquid crystal elements 120 when the scanning signal G1 attains an H level by the transfer of the second start pulse Dy will be updated when the scanning signal G1 attains an H level by the transfer of the third start pulse Dy, so that the voltages are held over a period of 1080H corresponding to the sub-field sf2.

Subsequently, when the 1080 cycles of the clock signal Cly have elapsed since the third start pulse Dy was output, the first start pulse Db is supplied to the shift register 136. Thus, the erasing scanning signals B1 to B1080 are obtained by sequentially delaying the first start pulse Db by one cycle of the clock signal Cly by the shift register 136. At this time, for example, as the i-th erasing scanning signal Bi attains an H level, the i-th row and j-th column liquid crystal element 120 is forcibly applied with an off voltage. Thus, the voltages that are written to the liquid crystal elements 120 when the scanning signal G1 attains an H level by the transfer of the third start pulse Dy are consequently held over a period of 1080H corresponding to the sub-field sf3.

Next, when the 720 cycles of the clock signal Cly have elapsed since the first start pulse Db was output, the fourth start pulse Dy is supplied to the shift register 132. Thus, the scanning signals G1 to G1080 are obtained by sequentially delaying the fourth start pulse Dy by one cycle of the clock signal Cly by the shift register 132. Here, when the scanning signal G1 attains an H level, the data signal dj has a gray-scale level specified to the i-th row and j-th column pixel and has a voltage that applies an on or off voltage to the liquid crystal element 120 in accordance with the sub-field sf4. In addition, in the i-th line, an off voltage that is forcibly written to each of the liquid crystal elements 120 when the erasing scanning signal Bi attains an H level by the transfer of the first start pulse Db will be updated when the scanning signal G1 attains an H level by the transfer of the fourth start pulse Dy, so that the off voltage is held over a period of 720H corresponding to the blank sub-field Bsf1.

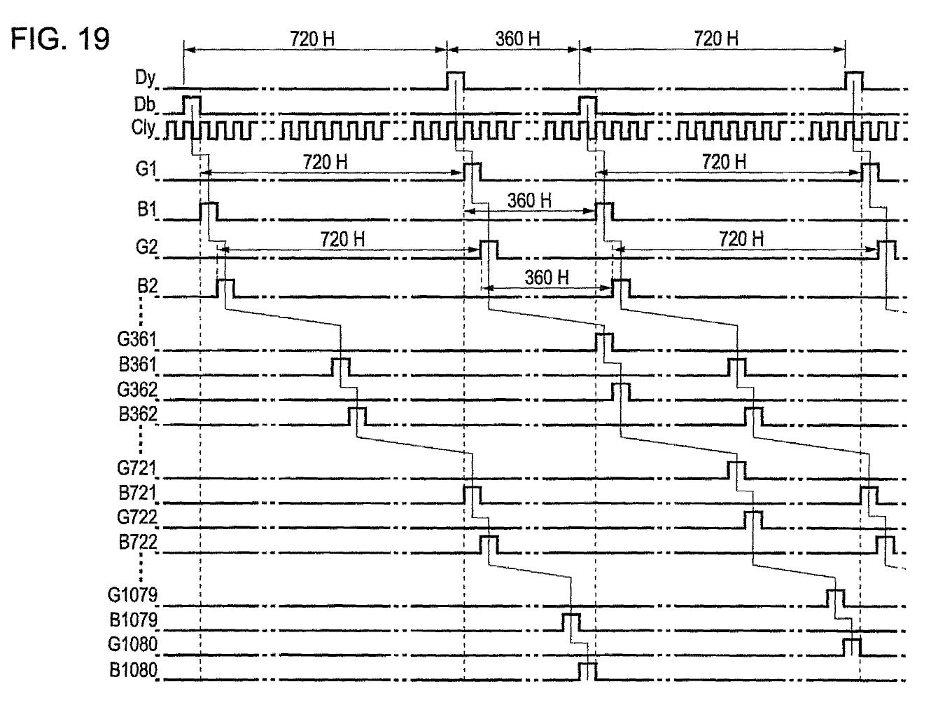

However, a period from time when the erasing scanning signal B1 changes from an L level to an H level by the transfer of the first start pulse Db to time when the erasing scanning signal B1080 changes from an H level to an L level and a period from time when the scanning signal G1 changes from an L level to an H level by the transfer of the fourth start pulse Dy to time when the scanning signal G1080 changes from an H level to an L level both are 1080H. Thus, when the scanning signals G1 to G360 sequentially attain an H level by the transfer of the fourth start pulse Dy, as shown in FIG. 19, the erasing scanning signals B721 to B1080 also sequentially attain an H level. Specifically, for example, when the scanning signal G1 is at an H level, the erasing scanning signal B721 is also at an H level. When the scanning signal G2 is at an H level, the erasing scanning signal B722 is also at an H level. Here, in the second embodiment, because the pixels 110 are configured as shown in FIG. 16, for example, writing of an on or off voltage to the first line when the scanning signal G1 is at an H level and writing of an off voltage to the 721st line when the erasing scanning signal B721 is at an H level are executed at the same time without influencing each other.

Next, when the 360 cycles of the clock signal Cly have elapsed since the fourth start pulse Dy was output, the second start pulse Db is supplied to the shift register 136. Thus, the erasing scanning signals B1 to B1080 are obtained by sequentially delaying the second start pulse Db by one cycle of the clock signal Cly by the shift register 136. At this time, for example, as the i-th erasing scanning signal Bi attains an H level, the i-th row and j-th column liquid crystal element 120 is forcibly applied with an off voltage. Thus, the voltages that are written to the liquid crystal elements 120 when the scanning line G1 attains an H level by the transfer of the fourth start pulse Dy are consequently held over a period of 360H corresponding to the sub-field sf4. Note that, when the erasing scanning signals B1 to B720 sequentially attain an H level by the transfer of the second start pulse Db, the scanning signals G361 to G1080 also sequentially attain an H level by the transfer of the fourth start pulse Dy.

Then, when the 720 cycles of the clock signal Cly have elapsed since the second start pulse Dy was output, in order to scan the sub-field sf1 in the next field, the first start pulse Dy is supplied to the shift register 132 and thereby the scanning signals G1 to G1080 sequentially attain an H level. Note that, because the polarity of writing will be inverted in the next field, when the preceding field is driven with positive polarity, the voltage polarity of a data signal is inverted to apply a negative polarity on or off voltage to the liquid crystal elements 120. Note that, when the scanning lines G1 to G360 sequentially attain an H level by the transfer of the first start pulse Dy, the erasing scanning signals B721 to B1080 also sequentially attain an H level by the transfer of the second start pulse Db.

In addition, in the i-th line, an off voltage that is written to each of the liquid crystal elements 120 when the erasing scanning signal Bi attains an H level by the transfer of the second start pulse Db will be updated when the scanning signal G1 attains an H level by the transfer of the first start pulse Dy in the next field, so that the off voltage is held over a period of 720H corresponding to the blank sub-field Bsf2.

FIG. 20 is a view that shows the progress of selection of the scanning lines and erasing scanning lines from the first to the 1080th in one field. In the drawing, selection of the scanning lines is shown with small dots; however, because the scanning lines are selected toward the lower side over time, the small dots are shown as solid lines that are continuous to the right lower direction. Similarly, the erasing scanning lines 113 are also selected toward the lower side over time, the dots are continuous to the right lower direction; however, the dots are shown by broken line in order to be differentiated from selection of the scanning lines 112. Note that, in FIG. 20, areas in which an off voltage is applied in the blank sub-fields Bsf1 and Bsf2 are shown with hatching.

A period required from time when the scanning signal G1 changes from an L level to an H level by the transfer of the start pulse Dy to time when the scanning signal G1080 changes from an H level to an L level or a period required from time when the erasing scanning signal B1 changes from an L level to an H level by the transfer of the start pulse Db to time when the erasing scanning signal B1080 changes from an H level to an L level needs to be set equal to or shorter than the sum of a period of the shortest sub-field sf4 and a period of any one of the blank sub-fields adjacent to the shortest sub-field sf4. The second embodiment is described in the case in which both the periods are set to 1080H and are made to coincide with each other.

In the second embodiment as described above, because scanning for applying an on or off voltage to the liquid crystal element and erasing scanning for forcibly setting the applied on or off voltage to an off voltage are executed by the mutually different scanning line 112 and erasing scanning line 113, it is possible to perform both the scanning and the erasing scanning independently of each other unless they are executed in the same line at the same time. That is, according to the second embodiment, as shown in FIG. 20, it is possible to execute scanning of the pixel to which an on or off voltage is applied to the liquid crystal element and erasing scanning of the pixel to which the applied on or off voltage is forcibly set to an off voltage at the same time. Thus, according to the second embodiment, because it is possible to set the period of the short sub-field sf4 shorter than a period required to select sequentially the scanning lines 112 from the first to the 1080th, it is possible to easily achieve improvement of the gray scale characteristics.

Note that, in the above described first or second embodiment, writing polarity is alternately switched between positive polarity and negative polarity once every period of one field; however, because alternate switching is performed not to apply a direct-current component to the liquid crystal, writing polarity may be, for example, switched once every two or more periods of one field. In addition, in the above described embodiments, the liquid crystal element 120 is described as a normally black mode; however, it may be a normally white mode that performs white display in a state of no voltage being applied. Furthermore, color display may be performed with dots, each of which is constituted of three pixels, that is, R (red), G (green) and B (blue). In addition, the liquid crystal element is not limited to a reflective type, but it may be of a transmissive type or of a transflective type that is intermediate between the reflective type and the transmissive type. In addition, the display element is not limited to a liquid crystal element, but the display element may be applied to, for example, devices that use an EL element, an electron emission element, an electrophoretic element or a digital mirror element, or a plasma display.

### Electronic Apparatus

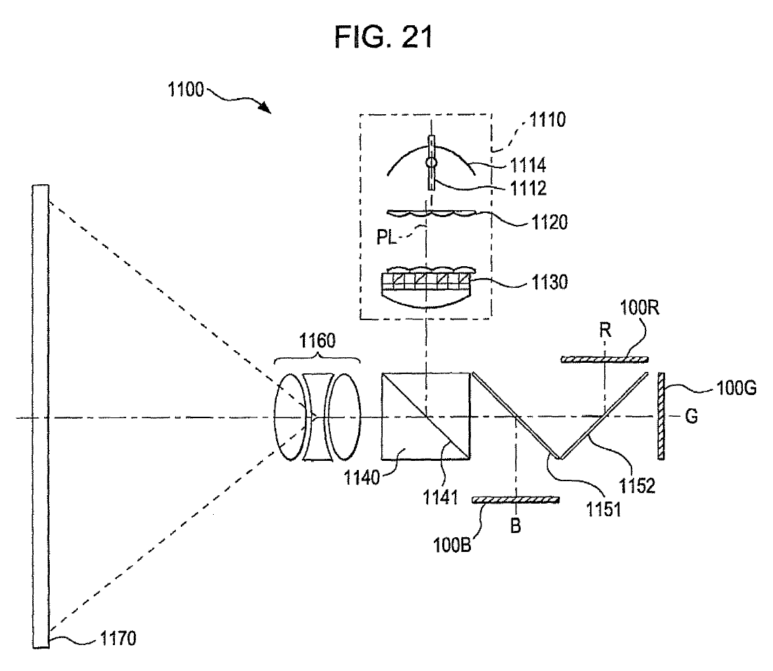

Next, as an example of an electronic apparatus that uses the electro-optical device according to the above described embodiments, a projector that uses the above described electro-optical device 1 as a light bulb will be described. FIG. 21 is a plan view of the configuration of the projector. As shown in the drawing, the projector 1100 is of a three panel type in which the three reflective electro-optical devices 1 according to the embodiments are respectively used for each of R (red), G (green) and B (blue). The projector 1100 includes a polarizer lighting device 1110 that is arranged along a system optical axis PL. In the polarizer lighting device 1110, light emitted from a lamp 1112 forms substantially parallel beams of light by being reflected on a reflector 1114 and enters a first integrator lens 1120. Owing to this first integrator lens 1120, light emitted from the lamp 1112 is split into a plurality of intermediate beams of light. These intermediate beams of light are converted into polarized beams of light (s polarized beams of light) of one kind, having substantially the same polarization direction by a polarization conversion element 1130 that includes a second integrator lens on the light incidence side, and then exits from the polarizer lighting device 1110.

The s polarized beams of light that exits from the polarizer lighting device 1110 are reflected on an s polarization beam reflection plane 1141 of the polarization beam splitter 1140. Among the reflected beams of light, beams of blue light (B) are reflected on a blue light reflection layer of the dichroic mirror 1151 and modulated by the reflective light bulb 100B. In addition, among beams of light that pass through the blue light reflection layer of the dichroic mirror 1151, beams of red light (R) are reflected on a red light reflection layer of the dichroic mirror 1152 and modulated by the reflective light bulb 100R. On the other hand, among beams of light that pass through the blue light reflection layer of the dichroic mirror 1151, beams of green light (G) pass through the red light reflection layer of the dichroic mirror 1152 and modulated by the reflective light bulb 100G. Here, the light bulbs 100R, 100G and 100B are the same as the display circuit 100 in the embodiments described above, and are driven by supplied data signals corresponding to colors of R, G and B, respectively. That is, in the projector 1100, the three electro-optical devices 1 that include the display circuits 100 are provided in correspondence with colors of R, G and B, and are driven with sub-fields in accordance with display data corresponding to colors of R, G and B.

Red, green and blue beams of light that are modulated by the light bulbs 100R, 100G, 100B are sequentially composed by the dichroic mirrors 1152, 1151 and the polarization beam splitter 1140 and, after that, projected onto a screen 1170 by the projection optical system 1160. Note that, because beams of light corresponding to primary colors of R, G and B respectively enter the light bulbs 100R, 100B and 100G by the dichroic mirrors 1151 and 1152, no color filters are required.

The electronic apparatus may be, in addition to the projector described with reference to FIG. 21, a television, a viewfinder type or direct view type video tape recorder, a car navigation system, a pager, a personal organizer, an electronic calculator, a word processor, a workstation, a video telephone, a POS terminal, a digital still camera, a cellular phone, or devices provided with a touch panel. Then, needless to say, the electro-optical device according to the aspects of the invention may be applied to these various electronic apparatuses.

The entire disclosure of Japanese Patent Application No. 2007-132664, filed May 18, 2007 is expressly incorporated by reference herein.

What is claimed is:

1. A driving circuit of an electro-optical device that includes a plurality of writing scanning lines, a plurality of data lines and a plurality of pixels arranged at positions corresponding to intersections of the writing scanning lines and the data lines, wherein each of the pixels, when a corresponding one of the writing scanning lines is selected, enters a state in accordance with a data signal supplied to the corresponding one of the data lines, wherein the electro-optical device performs gray scale by applying at least one of an on voltage or an off voltage to each of the pixels for each of a plurality of sub-fields into which one field is divided, the driving circuit comprising:
a scanning line driving circuit that selects the plurality of writing scanning lines in a predetermined order, wherein whether to apply an on or off voltage to the pixels is allocated in advance for each sub-field for each gray scale value that can be designated for the pixels; and
a data line driving circuit that, when one of the writing scanning lines is selected, supplies, over the data lines, data signals of on or off voltages that are allocated to the sub-field and for the gray scale designated for the pixels corresponding to the selected writing scanning, wherein among the plurality of sub-fields, wherein, among the sub-fields that constitute the one field, at least two sub-fields are set for the different lengths of time periods from each other, the length of a time period of the shortest sub-field is set shorter than the length of a time period required for the scanning line driving circuit to select the plurality of writing scanning lines.

2. The driving circuit of the electro-optical device according to claim 1, wherein
the writing scanning lines are formed in a row direction and the data lines are formed in a column direction, wherein
the scanning line driving circuit includes a shift register and logic circuits, wherein
the shift register has stages that are provided in correspondence with the plurality of rows of writing scanning lines and sequentially transfers a pulse, which is supplied at a time interval in accordance with each of the sub-fields, over the stages in accordance with a clock signal, wherein
the logic circuits each are provided for each of the plurality of rows of writing scanning lines, wherein each of the logic circuits logically operates a pulse that is overlappingly output from each of the stages of the shift register so as not to overlap one another among the plurality of rows and supplies the pulse to a corresponding one of the writing scanning lines as a scanning signal that indicates selection.

3. The driving circuit of the electro-optical device according to claim 2, wherein
the number of pulses that are overlappingly output from the stages of the shift register is “2”, wherein
the logic circuit provided in each of the rows outputs a logical multiplication signal of an enable signal and the shift register, and wherein
different enable signals are output between in the odd-numbered rows and in the even-numbered rows.

4. The driving circuit of the electro-optical device according to claim 2, wherein
the one field is divided into p (p is an integer that is equal to or more than two) groups and then each group is divided into two sub-fields, and wherein
the p groups are set to have the same length of a time period and the periods of the two sub-fields that constitute each group are respectively set short and long.

5. The driving circuit of the electro-optical device according to claim 1, further comprising:
an erasing scanning line that is provided so as to be paired with each of the plurality of writing scanning lines, wherein
each of the pixels, when a corresponding one of the erasing scanning lines is selected, is applied with an off voltage irrespective of the data signal, and wherein
the scanning line driving circuit selects one of the writing scanning lines in order to write an on or off voltage to each of the pixels in accordance with the sub-field of which the time period is the shortest and, when the time period of that sub-field has elapsed from the selection, selects the erasing scanning line that is paired with the one of the writing scanning lines.

6. The driving circuit of the electro-optical device according to claim 1, wherein
each of the pixels includes a liquid crystal element, wherein
among the sub-fields, the length of a time period of the shortest sub-field is set shorter than saturation response time that takes until the reflectance ratio or transmittance ratio of the liquid crystal element is saturated when the on voltage is applied to the liquid crystal element.

7. The driving circuit of the electro-optical device according to claim 1, wherein among displayable gray scales, in regard to a gray scale that is one level darker than the brightest gray scale, one of an on or off voltage is applied to each of the pixels in the sub-field that is set to the shortest length of a time period and the other one of an on or off voltage is applied to each of the pixels in another sub-field, and wherein
among the displayable gray scales, in regard to a gray scale that is one level brighter than the darkest gray scale, the other one of an on or off voltage is applied to each of the pixels in the sub-field that is set to the shortest length of a time period and the one of an on or off voltage is applied to each of the pixels in the another sub-field.

8. The driving circuit of the electro-optical device according to claim 1, wherein, in the sub-field, each of the pixels is applied with any one of the on voltage, the off voltage or an intermediate voltage that is set to a voltage between the on voltage and the off voltage.

9. A method of driving an electro-optical device that includes a plurality of writing scanning lines, a plurality of data lines and a plurality of pixels arranged at positions corresponding to intersections of the writing scanning lines and the data lines, wherein each of the pixels, when a corresponding one of the writing scanning lines is selected, enters a state in accordance with a data signal supplied to the corresponding one of the data lines, wherein the electro-optical device performs gray scale by applying at least one of an on voltage or an off voltage to each of the pixels for each of a plurality of sub-fields into which one field is divided, the method comprising:
setting, among the sub-fields that constitute the one field, at least two sub-fields for the different lengths of time periods from each other;
allocating whether to apply an on or off voltage to the pixels in advance for each sub-fields for each gray scale value that can be designated for the pixels;
selecting the plurality of writing scanning lines in a predetermined order;
when one of the writing scanning lines is selected, supplying data signals of an on or off voltages that are allocated to the sub-field and gray scale designated for the pixels corresponding to the selected writing scanning; and
among the plurality of sub-fields, setting the length of a time period of the shortest sub-field shorter than the length of a time period required to select the plurality of writing scanning lines.

10. An electro-optical device comprising:
a plurality of writing scanning lines;
a plurality of data lines;
a plurality of pixels arranged at positions corresponding to intersections of the writing scanning lines and the data lines, wherein each of the pixels, when a corresponding one of the writing scanning lines is selected, enters a state in accordance with a data signal supplied to the corresponding one of the data lines, wherein the electro-optical device performs gray scale by applying at least one of an on voltage or an off voltage to each of the pixels for each of a plurality of sub-fields into which one field is divided;
a scanning line driving circuit that selects the plurality of writing scanning lines in a predetermined order, wherein whether to apply an on or off voltage to the pixels is allocated in advance for each sub-field for each gray scale value that can be designated for the pixels; and
a data line driving circuit that, when one of the writing scanning lines is selected, supplies, over the data lines, data signals of on or off voltages that are allocated to the sub-field and for the gray scale designated for the pixels corresponding to the selected writing scanning, wherein among the plurality of sub-fields, wherein, among the sub-fields that constitute the one field, at least two sub-fields are set for the different lengths of time periods from each other, the length of a time period of the shortest sub-field is set shorter than the length of a time period required for the scanning line driving circuit to select the plurality of writing scanning lines.

11. An electronic apparatus comprising the electro-optical device according to claim 10.
